(19) United States
(12) Patent Application Publication
(10) Pub. No.: US 2023/0089249 A1
(43) Pub. Date: Mar. 23, 2023

(54) NOZZLE TURRET WITH AN ACCELERATING STREAM CONDITIONER FOR A ROTATING IRRIGATION SPRINKLER

(71) Applicant: Hunter Industries, Inc., San Marcos, CA (US)

(72) Inventor: James A. Bell, Vista, CA (US)

(21) Appl. No.: 17/655,986

(22) Filed: Mar. 22, 2022

Related U.S. Application Data
(63) Continuation-in-part of application No. 17/447,869, filed on Sep. 16, 2021.

(51) Int. Cl. B05B 3/04; B05B 1/10

(52) U.S. Cl. CPC B05B 3/0422; B05B 1/10

(57) ABSTRACT

A rotating sprinkler for irrigation is disclosed. The sprinkler can include a turret and a stream conditioner positioned in the turret. The stream conditioner can include a plurality of fins forming a plurality of flow regions. One or more of the plurality of flow regions can have a cross-sectional flow area that decreases in a downstream direction towards the primary port so as to accelerate the pressurized water through the stream conditioner. The plurality of fins can further straighten the water.

### CROSS REFERENCE TO RELATED APPLICATION

This application is a continuation-in-part of U.S. Pat. Application No. 17/447,869, filed Sep. 16, 2021, titled “NOZZLE TURRET WITH AN ACCELERATING STREAM CONDITIONER FOR A ROTATING IRRIGATION SPRINKLER,” the entirety of which is hereby incorporated by reference.

### TECHNICAL FIELD

The present inventions relate to apparatus for irrigating turf and landscaping, and more particularly, to rotor-type sprinklers having a turbine that rotates a nozzle through a gear train reduction.

### BACKGROUND

In many parts of the United States, rainfall is insufficient and/or too irregular to keep turf and landscaping green and therefore irrigation systems are installed. Such systems typically include a plurality of underground pipes connected to sprinklers and valves; the latter being controlled by an electronic irrigation controller. One of the most popular types of sprinklers is a pop-up rotor-type sprinkler. In this type of sprinkler, a tubular member is normally retracted into an outer cylindrical case by a coil spring. The case is buried in the ground and when pressurized water is fed to the sprinkler the tubular member extends. A turbine and a gear train reduction are mounted in the tubular member for rotating a nozzle turret at the top of the tubular member. The gear train reduction is often encased in its own housing and is often referred to as a gear box. A reversing mechanism is also normally mounted in the tubular member along with an arc adjustment mechanism.

The gear drive of a rotor-type sprinkler can include a series of staggered gears and shafts. A small gear on the top of the turbine shaft drives a large gear on the lower end of an adjacent second shaft. Another small gear on the top of the second shaft drives a large gear on the lower end of a third shaft, and so on. Alternately, the gear drive can comprise a planetary arrangement in which a central shaft carries a sun gear that simultaneously drives several planetary gears on rotating circular partitions or stages that transmit reduced speed rotary motion to a succession of similar rotating stages. It is common for the planetary gears of the stages to engage corresponding ring gears formed on the inner surface of the housing. In some cases, the planetary gear box is a reversing planetary gear box. See, for example, U.S. Pat. No. 10,786,823 granted to Clark et al.

### SUMMARY

According to some embodiments, a rotating sprinkler for irrigation can include a turret configured to rotate with the sprinkler and comprising a chamber, an inlet in flow communication with the chamber, the inlet being configured to receive pressurized water, a primary port in flow communication with the chamber, the primary port being configured to receive a primary nozzle, and a stream conditioner comprising a plurality of fins forming a plurality of flow regions. One or more of the plurality of flow regions can have a cross-sectional flow area that decreases in a downstream direction towards the primary port so as to accelerate the pressurized water through the stream conditioner.

A variation of the aspect above is, wherein at least a portion of the stream conditioner is disposed in the primary port.

A variation of the aspect above is, wherein the portion of the stream conditioner forms a press fit in the primary port.

A variation of the aspect above is, wherein the stream conditioner comprises an engagement structure configured to align the stream conditioner with the primary port.

A variation of the aspect above is, wherein the stream conditioner can rotate for less than 360 degrees about its axis relative to the primary port when installed in the turret.

A variation of the aspect above is, wherein the stream conditioner can rotate for less than 5 degrees about its axis relative to the primary port when installed in the turret.

A variation of the aspect above is, wherein the engagement structure of the stream conditioner is one or more notches.

A variation of the aspect above is, wherein the turret comprises an engagement structure configured to engage with the stream conditioner.

A variation of the aspect above is, wherein the engagement structure of the turret is one or more bosses.

A variation of the aspect above is, wherein the plurality of flow regions have a cross-sectional flow area that decreases in a downstream direction towards the primary port.

A variation of the aspect above further comprises a nozzle assembly having at least the primary nozzle, wherein the turret comprises a nozzle recess, the primary port being disposed in the nozzle recess, and wherein at least a portion of the nozzle assembly and at least a portion of the stream conditioner are sized and shaped to fit within the nozzle recess.

According to some embodiments, a rotating sprinkler for irrigation includes an outer body and a tubular structure disposed at least partially in the outer body, the tubular structure being in flow communication with an inlet of the sprinkler, a turret supported by the tubular structure and comprising a chamber, an inlet in flow communication with the tubular structure and the chamber, and a nozzle recess in flow communication with the chamber, the nozzle recess being configured to receive a nozzle assembly. The rotating sprinkler further includes a stream conditioner positioned in the nozzle recess. The stream conditioner can have a central axis and comprising a plurality of fins with one or more flow areas disposed between the plurality of fins, the one or more flow areas having a cross-sectional flow area that decreases in a downstream direction so as to accelerate the water through the stream conditioner.

A variation of the aspect above is, wherein the one or more flow areas are arranged to form a central flow region and a perimeter flow region for water to flow through the stream conditioner.

A variation of the aspect above is, wherein the stream conditioner forms a press fit in the nozzle recess.

A variation of the aspect above is, wherein the stream conditioner comprises an engagement structure configured to engage with the turret.

A variation of the aspect above is, wherein the engagement structure of the stream conditioner is one or more notches.

A variation of the aspect above is, wherein the turret comprises an engagement structure configured to engage with the stream conditioner.

A variation of the aspect above is, wherein the engagement structure of the turret is one or more bosses.

According to some embodiments, a rotating sprinkler for irrigation includes a housing configured to rotate with the sprinkler and comprising an internal chamber, an inlet disposed in a lower surface of the housing, the inlet being in flow communication with the internal chamber and configured to receive pressurized water, an outlet in a sidewall of the housing, the outlet being in flow communication with the chamber and sized and shaped to receive a primary nozzle, and a stream conditioner positioned upstream from the outlet and comprising a plurality of fins sized and shaped to straighten and accelerate a turbulent flow of water from the internal chamber as the water passes between the plurality of fins. The plurality of fins can have one or more flow areas disposed between the plurality of fins. The one or more flow areas having a cross-sectional flow area that decreases in a downstream direction towards the outlet so as to accelerate the water through the stream conditioner.

A variation of the aspect above is, wherein the outlet comprises a primary port, the primary port being configured to receive at least a portion of the stream conditioner.

According to some embodiments, a sprinkler can include a stator, a turbine, a nozzle, a gear drive and a reversing mechanism coupled to a turret. The gear drive and reversing mechanism can rotatably couple the turbine and the nozzle. The gear drive and reversing mechanism can be coupled to shift a direction of rotation of an output stage of the gear drive. In some embodiments, the turbine rotates as water passes through it to drive the turret through the gear drive.

According to some embodiments, a rotating sprinkler for irrigation can include a housing having an inlet and an outlet, a turret mounted on the housing at the outlet and configured to be rotated about an axis relative to the housing, a drive mechanism configured to rotate the turret and having an input shaft, a turbine coupled to the input shaft and having a plurality of blades configured to generate torque for rotating the input shaft, and a stator spaced upstream from the turbine to form a mixing region therebetween. The turret can include one or more recesses to install one or more nozzles. Some turrets have one nozzle installed. Some turrets have two or more nozzles installed. When water is flowing through the sprinkler, the nozzle, or combination of nozzles, will distribute water outward from the sprinkler. As the turret rotates, water is distributed over an area of landscape to irrigate that portion of the landscape. In some embodiments, the nozzle turret can comprise a stream conditioner to direct the water and accelerate the velocity of the water entering a nozzle.

According to some embodiments, a rotating sprinkler for irrigation can include a turret configured to rotate with the sprinkler. The turret can include a chamber, an inlet in flow communication with the chamber, the inlet being configured to receive pressurized water, a primary port in flow communication with the chamber, the primary port being configured to receive a primary nozzle, and a stream conditioner positioned in the chamber and upstream from the primary port. The stream conditioner can include a plurality of fins forming a plurality of flow regions. One or more of the plurality of flow regions can have a cross-sectional flow area that decreases in a downstream direction towards the primary port so as to accelerate the pressurized water through the stream conditioner.

A variation of the aspect above is, wherein the plurality of flow regions comprise a central flow region and a perimeter flow region.

A variation of the aspect above is, wherein the perimeter flow region encircles the central flow region.

A variation of the aspect above is, wherein the one or more of the plurality of flow regions having a cross-sectional flow area that decreases in a downstream direction towards the primary port is located in the perimeter flow region.

A variation of the aspect above is, wherein the plurality of fins are water-straightening fins.

A variation of the aspect above is, wherein the perimeter flow region comprises a wall that forms a conical shape.

A variation of the aspect above is, wherein leading edges of the plurality of fins forms a flat input side into the stream conditioner.

A variation of the aspect above is, wherein leading edges of the plurality of fins have a tapered shape.

A variation of the aspect above further comprises a nozzle assembly having at least the primary nozzle, wherein the turret comprises a nozzle recess, the primary port being disposed in the nozzle recess, and wherein at least a portion of the nozzle assembly is sized and shaped to fit within the nozzle recess.

According to some embodiments, a rotating sprinkler for irrigation can include an outer body and a tubular structure disposed at least partially in the outer body, the tubular structure being in flow communication with an inlet of the sprinkler. The sprinkler can further include a turret supported by the tubular structure and having a chamber, an inlet in flow communication with the tubular structure and the chamber, and a nozzle recess in flow communication with the chamber, the nozzle recess being configured to receive a nozzle assembly. The sprinkler can further include a stream conditioner positioned in the chamber and upstream from the nozzle recess. The stream conditioner can have a central axis and a plurality of fins arranged to form a central flow region and a perimeter flow region for water to flow through the stream conditioner. At least a portion of the perimeter flow region can be nonparallel to the central axis so as to accelerate the water through the stream conditioner.

A variation of the aspect above is, wherein the central flow region comprises a single subregion.

A variation of the aspect above is, wherein the perimeter flow region comprises two or more subregions.

A variation of the aspect above is, wherein the stream conditioner further comprises a skirt sized and shaped to surround a portion of the nozzle assembly.

A variation of the aspect above is, wherein the stream conditioner further comprises one or more retention tabs, and wherein the turret further comprises a holding boss, the holding boss being configured to engage the one or more retention tabs to secure the stream conditioner in the chamber.

According to some embodiments, a rotating sprinkler for irrigation can include a housing configured to rotate with the sprinkler. The housing can include an internal chamber and an inlet disposed in a lower surface of the housing. The inlet can be in flow communication with the internal chamber and configured to receive pressurized water. The sprinkler can include an outlet in a sidewall of the housing, the outlet being in flow communication with the chamber and sized and shaped to receive a primary nozzle and a stream conditioner positioned in the internal chamber and upstream from the outlet. The stream conditioner can include a plurality of fins sized and shaped to straighten and accelerate a turbulent flow of water from the internal chamber as the water passes between the plurality of fins.

A variation of the aspect above is, wherein the plurality of fins form a plurality of flow regions.

A variation of the aspect above is, wherein the plurality of flow regions comprise a central flow region and a perimeter flow region.

A variation of the aspect above is, wherein the perimeter flow region encircles the central flow region.

A variation of the aspect above is, wherein the perimeter flow region comprises two or more subregions.

A variation of the aspect above is, wherein a least a portion of the stream conditioner comprises a wall adjacent to the at least one of the fins to form a cross-sectional flow area that decreases in a downstream direction from a leading edge to a trailing edge of the plurality of fins.

### BRIEF DESCRIPTION OF THE DRAWINGS

FIG. 1 is a view of an assembled gear driven sprinkler that includes an outer body and a tubular structure in a retracted position within the outer body according to certain embodiments of the present disclosure.

FIG. 2 is similar to FIG. 1 except the tubular structure has moved to an extended position relative to the outer body.

FIG. 3 is a front elevation view of the sprinkler of FIG. 2.

FIG. 4 is a section view of the sprinkler of FIG. 3 cut along the cut line 4-4.

FIG. 5 is an exploded view of certain components of the sprinkler of FIG. 1.

FIG. 6 is an embodiment of a sprinkler similar to the sprinkler of FIG. 1 except the tubular structure does not retrack and instead is disposed at a fixed height relative to a base.

FIG. 7 is an exploded view of the sprinkler of FIG. 6.

FIG. 8 is a front elevation view of the turret from both FIGS. 1 and 6 and shows a nozzle assembly installed in the turret.

FIG. 9 is a section view of the turret of FIG. 8 cut along the cut line 9-9 and shows a stream conditioner disposed in the turret in flow communication with the primary nozzle of the nozzle assembly.

FIG. 10 is an enlarged view similar to FIG. 9 except the nozzle assembly is removed from the turret and shows a plurality of flow streams passing through the stream conditioner including at least one central flow stream and a perimeter flow stream.

FIG. 11 is a perspective view of the turret from both FIGS. 1 and 6 with the nozzle assembly installed.

FIG. 12 is a section view of the turret of FIG. 11 cut along the cut line 12-12 of FIG. 11.

FIG. 13 is an exploded view of the turret of FIG. 11.

FIG. 14 is a front view of the stream conditioner from FIG. 13.

FIG. 15 is right side view of the stream conditioner of FIG. 14.

FIG. 16 is a section view of the stream conditioner of FIG. 14 cut along the cut line 16-16 of FIG. 14.

FIG. 17 is a back perspective view of the stream conditioner of FIG. 14.

FIG. 18 is a front perspective view of the stream conditioner of FIG. 14.

FIG. 19 is a perspective view of another embodiment of a turret similar to the turret of FIG. 11 except the turret of FIG. 19 includes a secondary nozzle on an opposite side of the turret from the primary nozzle.

FIG. 20 is a front elevation view of the turret of FIG. 19.

FIG. 21 is a section view of the turret of FIG. 19 cut along the cut line 21-21 of FIG. 20.

FIG. 22 is an exploded view of the turret of FIG. 19.

FIG. 23 is a front view of another embodiment of a stream conditioner that has a flat input side.

FIG. 24 is right side view of the stream conditioner of FIG. 23.

FIG. 25 is a section view of the stream conditioner of FIG. 23 cut along the cut line 25-25 of FIG. 23.

FIG. 26 is a front perspective view of the stream conditioner of FIG. 23.

FIG. 27 is a back perspective view of the stream conditioner of FIG. 23.

FIG. 28 is a front view of another embodiment of a stream conditioner with a flat input side and an open central flow region.

FIG. 29 is right side view of the stream conditioner of FIG. 28.

FIG. 30 is a section view of the stream conditioner of FIG. 28 cut along the cut line 30-30 of FIG. 28.

FIG. 31 is a front perspective view of the stream conditioner of FIG. 28.

FIG. 32 is a back perspective view of the stream conditioner of FIG. 28.

FIG. 33 is a section view of another embodiment of a turret similar to the turret of FIG. 9 except the stream conditioner of FIG. 33 is disposed inside a nozzle port upstream of a nozzle.

FIG. 34 is an exploded view of the turret of FIG. 33 illustrating, for example, a body configured to receive the stream conditioner via a nozzle recess.

FIG. 35 is a perspective view of the body from FIG. 34 and shows a boss positioned in the nozzle recess to engage with the stream conditioner.

FIG. 36 is an isometric view of the stream conditioner from FIG. 34 and shows a notch positioned to engage with the boss when the stream conditioner is installed in the nozzle recess.

FIG. 37 is a back view of the stream conditioner of FIG. 34.

FIG. 38 is a section view of the stream conditioner of FIG. 34 cut along the cut line 38-38 of FIG. 37.

FIG. 39 illustrates an embodiment of a stream conditioner that is similar to the stream condition illustrated in FIG. 37 except the central flow region does not include any fins.

### DETAILED DESCRIPTION

Irrigation sprinklers can be used to distribute water to turf and other landscaping. Types of irrigations sprinklers include pop-up, rotor-type, impact, spray and/or rotary-stream sprinklers. In some applications, multiple irrigation sprinklers can be used to water a targeted area. One or more controllers (e.g., wireless and/or wired controllers) can be used to control the operation of multiple irrigation sprinklers. For example, one or more controllers can control when each of the sprinklers of the irrigation system transitions between an irrigating (e.g., ON) configuration and a non-irrigating (e.g., OFF) configuration. In some embodiments, the one or more controllers control the amount of time the sprinklers operate.

According to the present disclosure, as illustrated and described below, a rotor-type sprinkler 100 can include a stator 116 to direct water to a turbine 118. The turbine 118 can be connected to the input of a gear box 120 to drive a turret 106 in a circular fashion at a desired speed to properly distribute water over an irrigated area. The turret 106 can be configured to hold a removable nozzle assembly 108.

In certain embodiments, the nozzle assembly 108 includes one or more nozzles. Each of the one or more nozzles can be a separate component installed into the turret 106 or can be combined with one or more nozzles to form the nozzle assembly 108. For example, in certain embodiments, the nozzle assembly 108 can include a primary nozzle 146 and one or more secondary nozzles 142, 144. In certain embodiments, the one or more secondary nozzle 142, 144 can be formed as a unitary structure with the primary nozzle 146 or can be separate structures. In other words, each nozzle can be an individual nozzle.

For example, the one or more secondary nozzles 142, 144 can be combined with the primary nozzle 146 to form a set of three nozzles. In certain embodiments, the one or more secondary nozzles 142, 144 are spaced along the circumference of the turret 106 at a distance from the primary nozzle 146. For example, in certain embodiments, the one or more secondary nozzles 142, 144 are disposed on opposite sides of the turret 106 from the primary nozzle 146.

In certain embodiments disclosed herein, a chamber 160 disposed within a body 152 of the turret 106 receives water that flows from the stator 116 and into the turret 106 before the water exits an outlet 107 via the nozzle assembly 108. In certain embodiments, the turret 106 can have a stream conditioner 140 positioned between the chamber 160 and the nozzle assembly 108. One or more stream conditioners 140 can be associated with one or more nozzles of the nozzle assembly 108. In the illustrated embodiment, one stream conditioner 140 is associated with the primary nozzle 146. In other embodiments, a stream conditioner 140 is associated with each nozzle.

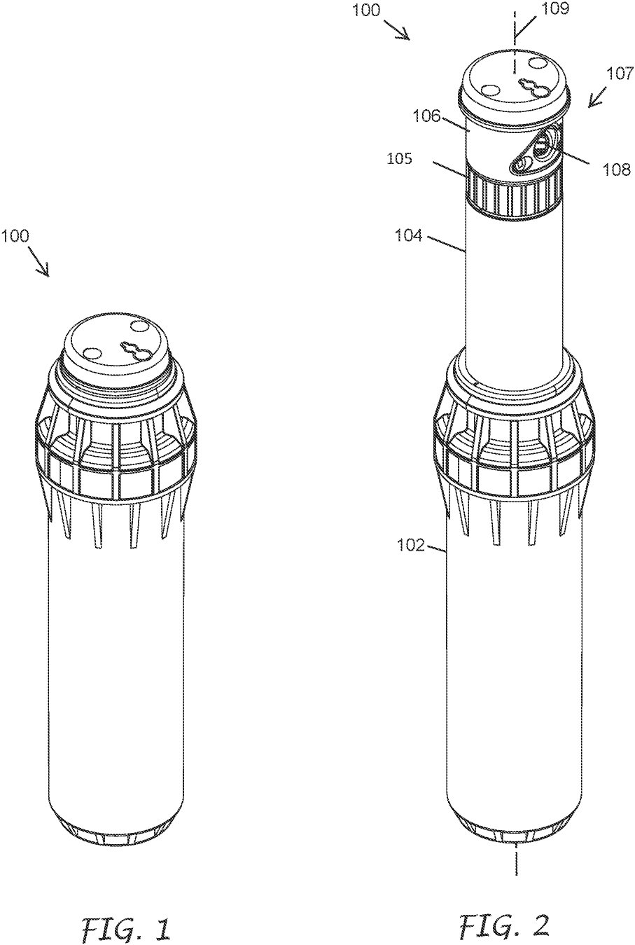

FIG. 1 is a view of an assembled gear driven sprinkler 100 according to an embodiment of the present disclosure. In certain embodiments, the sprinkler 100 includes an outer body 102 and a tubular structure 104. The sprinkler 100 further includes an inlet 110 (FIG. 4) for water to enter the sprinkler 100 and an outlet 107. In FIG. 1, the tubular structure 104 is in a retracted position within the outer body 102. FIG. 2 is similar to FIG. 1 except the tubular structure 104 has moved to an extended position relative to the outer body 102. As is illustrated in FIG. 2, the sprinkler 100 includes a turret 106 mounted at the outlet 107. In certain embodiments, the turret 106 supports one or more nozzles configured to spray water from the sprinkler 100. In certain embodiments, the turret 106 is configured to rotate about an axis 109 of the tubular structure 104 to allow the one or more nozzles to distribute the water across the turf or other landscaping. In certain embodiments, the sprinkler 100 further comprises an arc adjusting ring 105.

In certain embodiments, the tubular structure 104 can extend away from the outer body 102 to the extended position when water pressure is applied to the inlet 110 and then retract to the retracted position when the water pressure is removed. In certain embodiments, the tubular structure 104 is at least partially retracted back into the outer body 102 when in the retracted position.

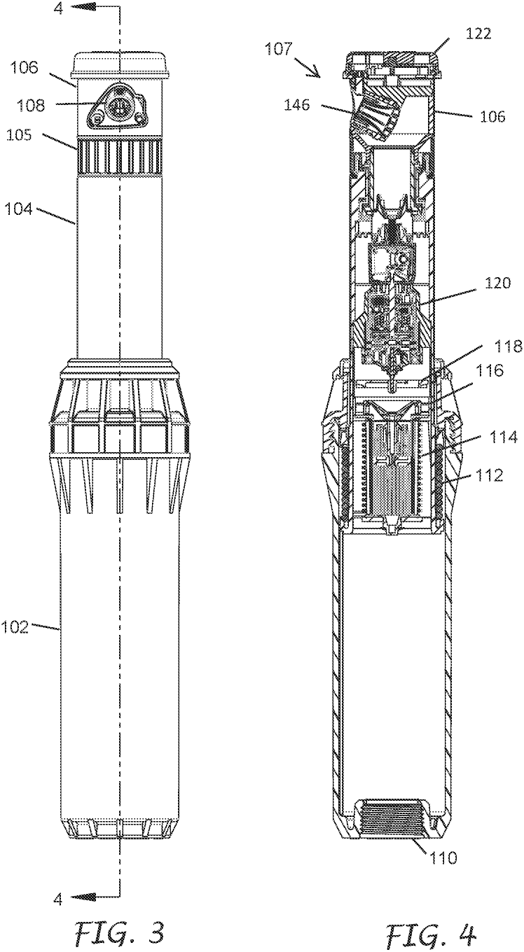

FIG. 3 is a front elevation view of the sprinkler 100 of FIG. 2. In the illustrated embodiment, the tubular structure 104 is in the extended position with the one or more nozzles of the turret 106 rotated about the axis 109 to face to the forward in FIG. 3. In the illustrated embodiment, the one or more nozzles form a nozzle assembly 108.

FIG. 4 is a section view of the sprinkler 100 of FIG. 3 cut along the cut line 4-4 of FIG. 3. In the embodiment of the sprinkler 100 illustrated in FIG. 4, a portion of the tubular structure 104 is extended away from the outer body 102.

In certain embodiments, the sprinkler 100 includes a spring 112. In certain embodiments, the spring 112 is configured to bias the tubular structure 104 to move toward the retracted position. In certain embodiments, the spring 112 has a spring constant which causes the spring 112 to compress when the inlet 110 is pressurized with water and retract in the absence of pressurized water. For example, the spring 112 is compressed when the tubular structure 104 is in the position illustrated in FIG. 4. When the water pressure is removed, the spring 112 expands to force the tubular structure 104 to lower back at least partially into the outer body 102 to a position shown in FIG. 1.

In certain embodiments, the sprinkler 100 can contain a screen 114 configured to filter the water entering the inlet 110. In the illustrated embodiment, the screen 114 is disposed in the tubular structure 104. In certain embodiments, the screen 114 is disposed downstream of the inlet 110 to prevent some dirt, rocks, algae, and other materials from flowing with the water through the sprinkler 100.

The sprinkler 100 comprises a stator 116 and a turbine 118. In certain embodiments, the turbine 118 is located downstream of the stator 116. In this way, in certain embodiments, water enters the turbine 118 after passing through and/or by the stator 116. In certain embodiments, at least some of the water that passes through the stator 116 also passes through the turbine 118. In certain embodiments, at least some of the water that passes through the turbine 118 does not pass through the stator 116. In certain embodiments, the amount of water that passes through the stator 116 and that also passes through the turbine 118 varies depending on, for example, one or more of variations in flow rate, variations in water pressure, changes in size of the one or more nozzles 108, and changes in rotation rate of the turret 106.

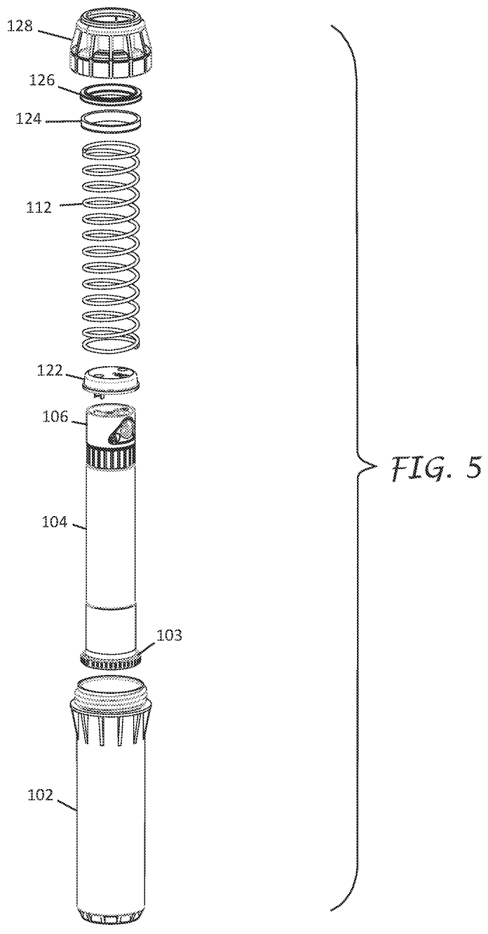

FIG. 5 is an exploded view of certain components of the sprinkler 100 of FIG. 1. In certain embodiments, the sprinkler 100 includes the outer body 102. The outer body 102 can be sized and shaped to receive at least a portion of the tubular structure 104 when the tubular structure 104 moves between the extended and retracted positions. In certain embodiments, the spring 112 can be disposed between an inner surface of the outer body 102 and the outer surface of the tubular structure 104. The spring 112 can be compressed between an annular member 103 of the tubular member 104 and a body cap 128. The body cap 128 secures to the outer body 102. In the illustrated embodiment, the body cap 128 is fastened by, for example, a thread to an upper end of the outer body 102 to encapsulate the spring 112.

In certain embodiments, the sprinkler 100 includes a cap 122. The cap 122 can be carried by the tubular structure 104 and cover a top surface of the tubular structure 104. In certain embodiments, the cap 122 comprises one or more openings that align with adjustment apertures in the turret 106. A user can access the adjustment apertures to change the operational characteristics of the sprinkler 100 with a tool via the one or more openings in the cap 122. In certain embodiments, the user can adjust the characteristics of the sprinkler 100 with the cap 122 removed.

In certain embodiments, the sprinkler 100 includes a seal 126 supported by a seal support 124. The seal 126 inhibits water from leaking from between the outer body 102 and the tubular member 104. The seal support 124 can maintain the integrity of the seal 126 when the spring 112 repeatedly compresses between the annular member 103 and the seal support 126.

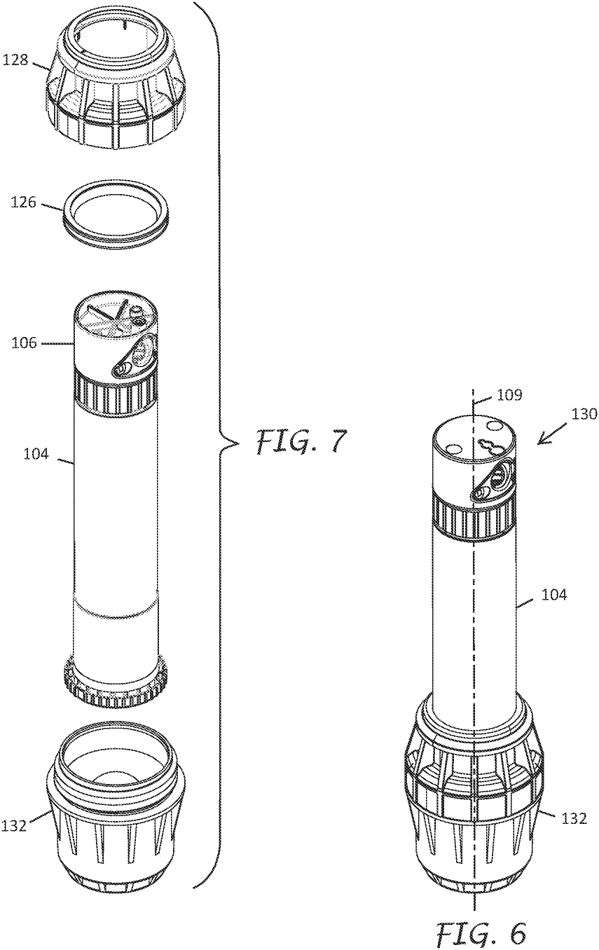

FIG. 6 is an embodiment of a sprinkler 130 similar to the sprinkler 100 of FIG. 1 except the tubular structure 104 does not retract and instead is disposed at a fixed height relative to a base 132. The base 132 takes the place of the outer body 102 in FIG. 1.

FIG. 7 is an exploded view of the sprinkler 130 of FIG. 6. In the illustrated embodiment, the tubular structure 104 is fixed relative to the base 132 with the turret 106 and the nozzle assembly 108 exposed above the base 132 and rotatable about the axis 109. Thus, the tubular structure 104 need not move between the retracted position and the extended position in certain embodiments. In certain fixed embodiments, the sprinkler 130 need not include the seal support 124.

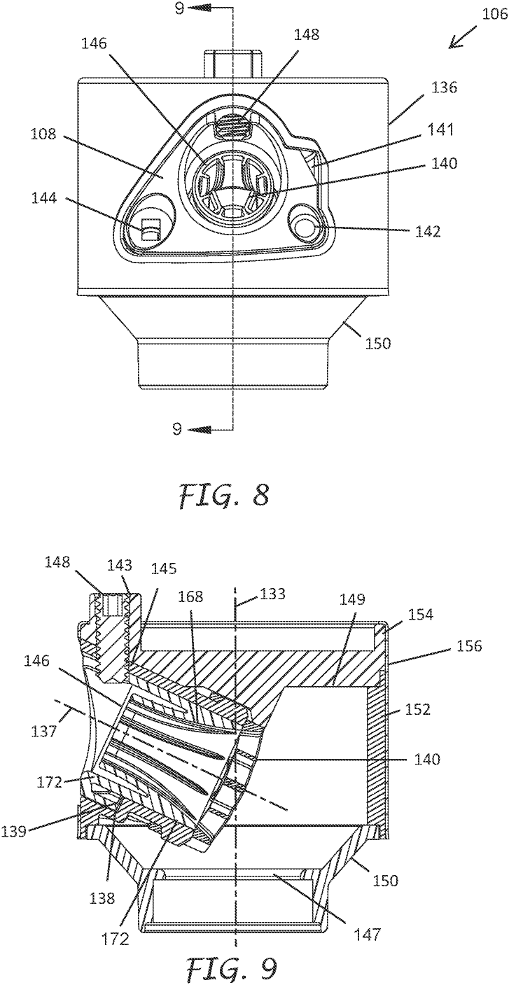

FIG. 8 is a front elevation view of the turret 106 from both FIGS. 1 and 6 and shows the nozzle assembly 108 installed in the turret 106. In certain embodiments, the turret 106 includes a turret housing 136 having an interior. The turret housing 136 can include a base 150 configured to mate with another component (e.g., a rotating drive within the tubular structure 104) of the sprinkler 100. In certain embodiments, the turret housing 136 includes a turret housing axis 133 (e.g., a centerline or longitudinal axis). The turret housing 136 can be configured to releasably mate with the nozzle assembly 108 having the one or more nozzles. In certain embodiments, one or more of the nozzles can be configured to individually releasably mate with the nozzle assembly 108.

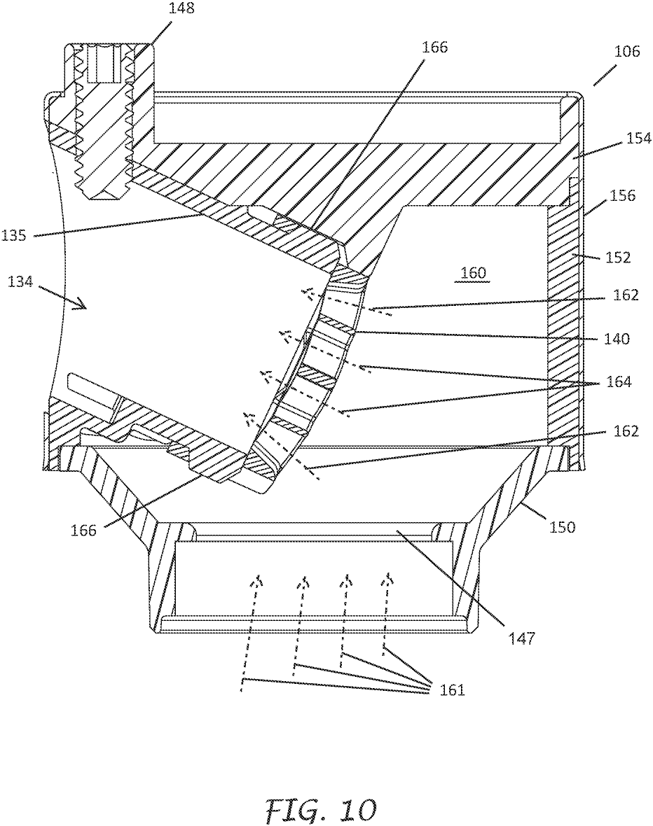

As illustrated, the turret 106 can include the nozzle assembly 108. The nozzle assembly 108 can be configured to releasably connect with the turret housing 136. For example, the nozzle assembly 108 can be configured to fit at least partially within a nozzle recess 135 (FIG. 10) in a sidewall of the turret housing 136.

The nozzle assembly 108 can include a plurality of nozzles. For example, the nozzle assembly 108 can include one primary nozzle 146. In some embodiments, the primary nozzle 146 includes an axis 137 extending substantially along a centerline of the primary nozzle 108.

In certain embodiments, the nozzle assembly 108 includes one or more secondary nozzles. For example, the nozzle assembly 108 can include a first secondary nozzle 142 and a second secondary nozzle 144. In the illustrated embodiment, the nozzle assembly 108 comprises the primary nozzle 146 flanked on both sides by the first and second secondary nozzles 142, 144. In other embodiments, the nozzle assembly 108 comprises a single nozzle. Thus, the nozzle assembly 108 is not limited to the illustrated embodiments and can comprises any number and spatial arrangements of nozzles.

The primary nozzle 146 and the first and second secondary nozzles 142, 144 can together form a unitary structure for insertion as the nozzle assembly 108 into the nozzle recess 135 in the turret 106. In other embodiments that include multiple nozzles, the nozzles can be separate nozzles individually inserted into the turret 106.

In some cases, nozzles of various spray ranges and/or spray patterns can be used in the same nozzle assembly 108. For example, the nozzle assembly 108 can include a short-range nozzle (e.g., a first secondary nozzle) configured to output water within a first range from the sprinkler on which the nozzle assembly 108 is installed. The nozzle assembly 108 can include a mid-range nozzle (e.g., a second secondary nozzle) configure to output water within or in a second range greater further from the sprinkler 100 than the first range. In certain embodiments, the nozzle assembly 108 includes a long range nozzle (e.g., primary nozzle 146) configured to output water within a third range further from the sprinkler 100 than the second range. According to some variants, the primary nozzle 146 functions as the short-range nozzle or as the mid-range nozzle. In some embodiments, one or more of the nozzles of the nozzle assembly 108 is configured to output in a radial pattern having wider coverage (e.g., covering an area with a larger circumferential width) than one or more of the other nozzles in the nozzle assembly 108.

The water passages through the nozzles of the nozzle assembly 108 can be selected to have any size or shape. For example, the water passages can have a circular, square, rectangular, or any other shape. In certain embodiments, the size and/or shape can be selected depending on the desired flow characteristics (e.g., spray range and/or spray pattern) for the sprinkler 100.

In some embodiments, the nozzle assembly 108 includes a mid-range secondary nozzle 142. In some embodiments, the mid-range secondary nozzle 142 is formed (e.g., injection molded or otherwise formed) as an integral part with the nozzle assembly 108. The nozzle assembly 108 can include two mid-range secondary nozzles 142. The mid-range secondary nozzle 142 can be configured to distribute water to cover an area between approximately 20 feet and 40 feet from the sprinkler 100 on which it is installed. In some cases, the mid-range secondary nozzle 142 is configured to distribute water to cover an area from about 10 feet to 30 feet, from about 30 feet to about 55 feet, from about 45 feet to 80 feet, and/or from about 75 feet to 90 feet from the sprinkler 100. Many variations are possible.

In certain embodiments, the nozzle assembly 108 can include a head water nozzle 144. In certain embodiments, the head water nozzle 144 (e.g., short-range nozzle) can be disposed on either side of the primary nozzle 146. In some embodiments, the head water nozzle 144 is formed (e.g., injection molded or otherwise formed) as an integral part with the nozzle assembly 108. The nozzle assembly 108 can include more than one head water nozzles 144, each integral with the nozzle assembly 108. The head water nozzle 144 can be configured to distribute water to cover an area within approximately 25 feet of the sprinkler 100 on which it is installed. In some cases, the head water nozzle 144 is configured to distribute water to cover an area within approximately 30 feet, within approximately 10 feet, within approximately 45 feet, and/or within approximately 75 feet of the sprinkler 100. Many variations are possible.

In some embodiments, the primary nozzle 146 is configured to distribute water from about 40 to 50 feet from the sprinkler 100 on which it is installed. The primary nozzle 146 can be configured to distribute water from about 30 to 45 feet, from about 45 to 60 feet, from about 50 to 90 feet, from about 90 to 110 feet, from about 40 to 85 feet, and/or further than 100 feet from the sprinkler 100. Many variations are possible.

In some cases, multiple (e.g., 2, 3, 4, 5, 6, or more) nozzle assemblies 108 (e.g., having varying nozzle sizes and/or shapes) are packaged with a sprinkler 100 to facilitate installation of a customized array of nozzles for a particular sprinkler 100. For example, the nozzle recess 135 of the turret 106 can be configured to couple with multiple nozzle assemblies 108 having differing spray patterns, output ranges, flow rates, trajectories, and/or other features. The multiple nozzle assemblies 108 can include nozzles having differences in port size, number of ports, and/or other features. For example, some nozzle assemblies 108 may have larger primary nozzles 146 than others to provide a higher flow rate primary nozzle. In some cases, the secondary nozzles 142, 144 of varying nozzle assemblies 108 can also vary.

In some embodiments, the nozzle assembly 108 can include one or more orientation structures. The orientation structures of the nozzle assembly 108 can be configured to inhibit improper installation of the nozzle assembly 108 in the nozzle recess 135. For example, an outer perimeter of the nozzle assembly 108 can have an asymmetric shape that matches an opening into the nozzle recess 135.

FIG. 9 is a section view of the turret 106 of FIG. 8 cut along the cut line 9-9 and shows a stream conditioner 140 disposed in the turret 106 in flow communication with the primary nozzle 146 of the nozzle assembly 106. In some embodiments, a mating structure on the nozzle assembly 108 extends from the nozzle assembly 108 into the nozzle recess 135 when the nozzle assembly 108 is mated with the turret housing 136. For example, the nozzle assembly 108 can include a flange 138 extending into the nozzle recess 135. The flange 138 can have a generally cylindrical shape, a generally oval shape, or any other shape.

The mating structure in the nozzle recess 135 can be shaped to receive the flange 138 of the nozzle assembly 108. For example, the nozzle recess 135 can include a shoulder 139 sized and shaped to abut against the flange 138 of the nozzle assembly 108. When the flange 138 is not inserted in the nozzle recess 135, a cylindrical base of the primary nozzle 146 can be inserted in a primary port 134 of the turret 106 until the flange 138 engages the complementary shoulder 139. Thus, the primary port 134 functions as a socket for removably receiving at least a portion of the nozzle assembly 108.

The fit between the flange 138 and shoulder 139 can be tight enough to create a seal between the structures. For example, the fit can be tight enough to inhibit or prevent water from escaping from the interior of the nozzle assembly 108 other than through the one or more nozzles. In some embodiments, the fit is tight enough to inhibit or prevent inadvertent disconnection between the nozzle assembly 108 and the turret housing 136 without the use of any further mechanisms or methods of connection between the nozzle assembly 108 and the turret housing 136.

In certain embodiments, the turret 106 includes one or more fasteners configured to secure the nozzle assembly 108 to the turret housing 136. For example, the nozzle assembly 108 can include a screw 148 (e.g., a set screw). The screw 148 can be inserted through a hole 143 through a portion (e.g., a top portion 154) of the turret 106 and through a groove or hole 145 in a portion of the nozzle assembly 108 to lock the nozzle assembly 108 to the turret housing 136. In certain embodiments, the screw 148 engages with the nozzle assembly 108 to prevent the water pressure in the turret 106 from ejecting the nozzle assembly 108.

As illustrated in FIG. 8, the nozzle assembly 108 can include one or more gaps configured to facilitate removal of the nozzle assembly 108 from the turret housing 136. For example, in certain embodiments, the nozzle assembly 108 includes an opening 141 configured to receive a tool or other structure to pry the nozzle assembly 108 from the nozzle recess 135. For example, during removal of the nozzle assembly 108 from the turret housing 136, a portion of a tool (e.g., a screwdriver or other elongate tool) can be inserted into the opening 141 to wedge an outer edge of the nozzle assembly 108 out of the opening 141. Moving the outer edge of the nozzle assembly 108 out of the opening 141 can facilitate removal of the nozzle assembly 108 from the nozzle recess 135.

The turret housing 136 can include a turret inlet 147 in the base 150. The turret inlet 147 can be upstream from the chamber 160. The chamber 160 can include an upper wall 149 formed by a surface of the top portion 154. An inner surface on a body 152 of the turret 106 can form an outer wall of the chamber 160. In certain embodiments, the upper wall 149 inhibits or prevents passage of water past the nozzle assembly 108 other than through the stream conditioner 140 or through the first and second secondary nozzles 142, 144. In some embodiments, turbulence within the base 150 and the chamber 160 is reduced, as all of the water contacting the stream conditioner 140 of the primary nozzle 146 is directed through the primary nozzle 146. In certain embodiments, water enters the stream conditioner 140 from the chamber 160.

FIG. 10 is an enlarged view similar to FIG. 9 except the nozzle assembly 108 is removed from the turret 106 and shows a plurality of flow streams passing through the stream conditioner 140 including one or more central flow streams 164 and one or more perimeter flow streams 162. In certain embodiments, as water 161 is flowing in the turret 106, there is turbulence in the water. The stream conditioner 140 reduces the turbulence and straightens the flow path to better direct the water into the inlet side of the primary nozzle 146 improving performance of the primary nozzle 146. In certain embodiments, the stream conditioner 140 is shaped to accelerate the water passing through the stream conditioner 140. For example, in certain embodiments, the shape of the walls forming the one or more perimeter flow streams 162 accelerates the water before the water enters the primary nozzle 146 in the primary port 134.

In certain embodiments, the turret housing 136 includes a sleeve 156. In certain embodiments, the sleeve 156 forms an outer support structure for the assembled turret housing 136. For example, the support structure of the sleeve 156 can resist hoop or circumferential stresses created by pressurized water in the chamber 160. In certain embodiments, the sleeve 156 surrounds an outer perimeter of the top portion 154, the body 152, and/or the base 150. In certain embodiments, the sleeve 156 is made from stainless steel. In certain embodiments, the sleeve 156 can provide a hard smooth surface to improve aesthetics. In certain embodiments, the sleeve 156 can provide a hard smooth surface to provide wear resistance that is greater than plastic, especially when the turret 106 retracts into the outer body 102 or the body cap 128.

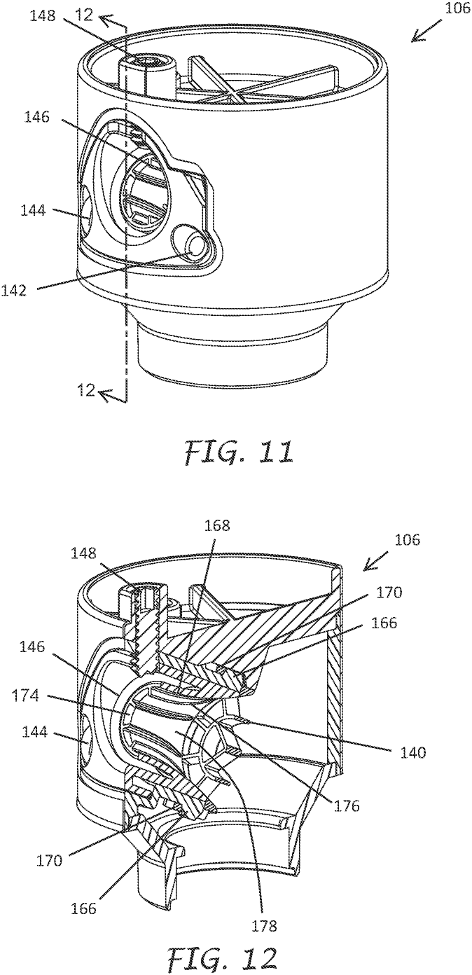

FIG. 11 is a perspective view of the turret 106 from both FIGS. 1 and 6 with the nozzle assembly 108 installed. FIG. 12 is a section view of the turret 106 of FIG. 11 cut along the cut line 12-12 of FIG. 11. The primary nozzle 146 can include a tapered portion 168. The tapered portion 168 can define an inlet to the primary nozzle 146 from the stream conditioner 140. The stream conditioner 140 is disposed upstream from the primary nozzle 146. In certain embodiments, the stream conditioner 140 can be connected to the tapered portion 168. In certain embodiments, the stream conditioner 140 is slightly spaced away from the inlet of the primary nozzle 146.

The tapered portion 168 of the primary nozzle 146 includes a tapered outlet 174. In certain embodiments, the tapered outlet 174 can include a plurality of fins 176. The plurality of fins 176 can be sized and shaped to straighten the water passing through the primary nozzle 146. In certain embodiments, the plurality of fins 176 are formed on a curved or elliptical inner wall 178 of the tapered outlet 174. In certain embodiments, the combination of the curved inner wall 178 and the plurality of fins 176 serves to keep turbulence to a minimum while accelerating the water prior to exiting the primary nozzle 146. It can be advantageous to maintain a smooth laminar flow of the water exiting the primary nozzle 146.

In certain embodiments, the tapered portion 168 is connected to a shroud 172. In certain embodiments, the shroud 172 extends around the nozzle assembly 108. The shroud 172 can overlap at least a portion of the tapered portion 168. In some embodiments, the shape of the shroud 172 defines a shape of an outer perimeter of the nozzle assembly 108. In some embodiments, the tapered portion 168 is connected to and/or extends from a front end of the shroud 172 in the region of the primary nozzle 146.

In some embodiments, the shroud 172 can be sized and shaped to fit at least partially within the nozzle recess 135. In some embodiments, portions of the shroud 172 (e.g., the flange 138) abut a surface of the stream conditioner 140 when the nozzle assembly 108 is mated with the nozzle recess 135. The shroud 172, or some other portion of the nozzle assembly 108, can include one or more recesses, nubs, breaks, gaps, protrusions, or other structures configured to engage with the structure of the nozzle recess 135.

In some embodiments, the at least a portion of the shroud 172 is sized to fit snuggly with the inter wall of the primary port 134. The fit between at least a portion of the shroud 172 and at least a portion of the primary port 134 can be tight enough to create a seal between the structures. For example, the fit can be tight enough to inhibit or prevent water from escaping from the interior of the nozzle assembly 108 past the shroud 172. In some embodiments, the fit is tight enough to inhibit or prevent inadvertent disconnection between the nozzle assembly 108 and the turret housing 136 without the use of any further mechanisms or methods of connection between the nozzle assembly 108 and the turret housing 136.

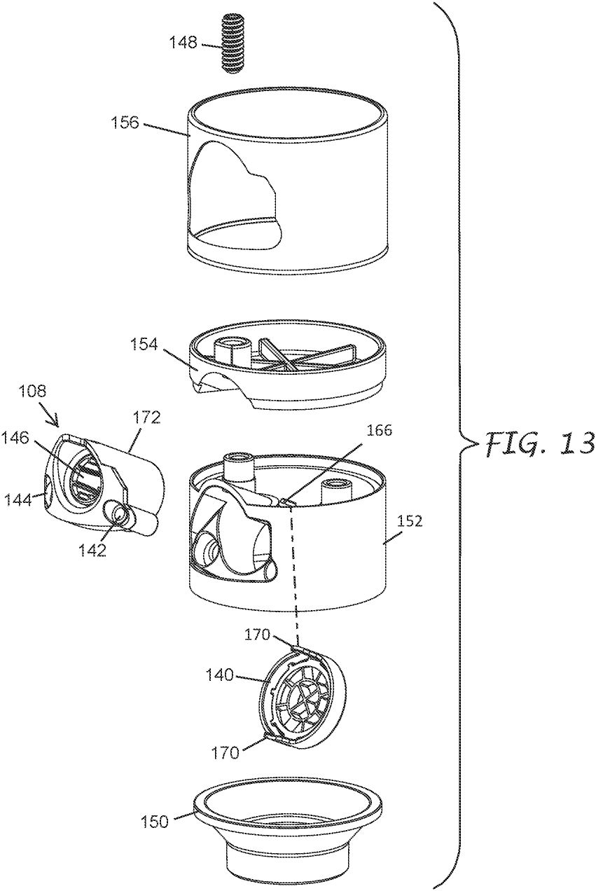

FIG. 13 is an exploded view of the turret 106 of FIG. 11. In certain embodiments, the stream conditioner 140 has a generally cylindrical configuration with a central axis 181 (FIG. 16). In other embodiments, the shape of the stream conditioner 140 can be square, oval, rectangular, or any other shape. In certain embodiments, the stream conditioner 140 includes a structure (e.g., detents, clips, or other attachment structures) that serves as an engagement structure to secure the stream conditioner 140 to the turret 106. In the illustrated embodiment, the stream conditioner 140 includes one or more retention tabs 170. Each of the one or more retention tabs 170 is configured to engage a holding boss 166 in the turret 106 to secure the stream conditioner 140 to the turret 106. For example, as illustrated, the turret 106 can include two holding bosses 166 positioned 180° from each other around a perimeter of the nozzle recess 135. In some embodiments, using two retention tabs 170 and two holding boss 166 as described above can facilitate mating of the stream conditioner 140 with the turret 106 in two rotational orientations, 180° apart rotationally. In certain embodiments, each of the retention tabs 170 includes a slot 194 sized and shaped to engage with the holding boss 166. When engaged, the slot 194 can prevent the stream conditioner 140 from falling backward into the chamber 160 when the sprinkler 100 is not pressurized. In other embodiments, the stream condition 140 is integral to the body 152.

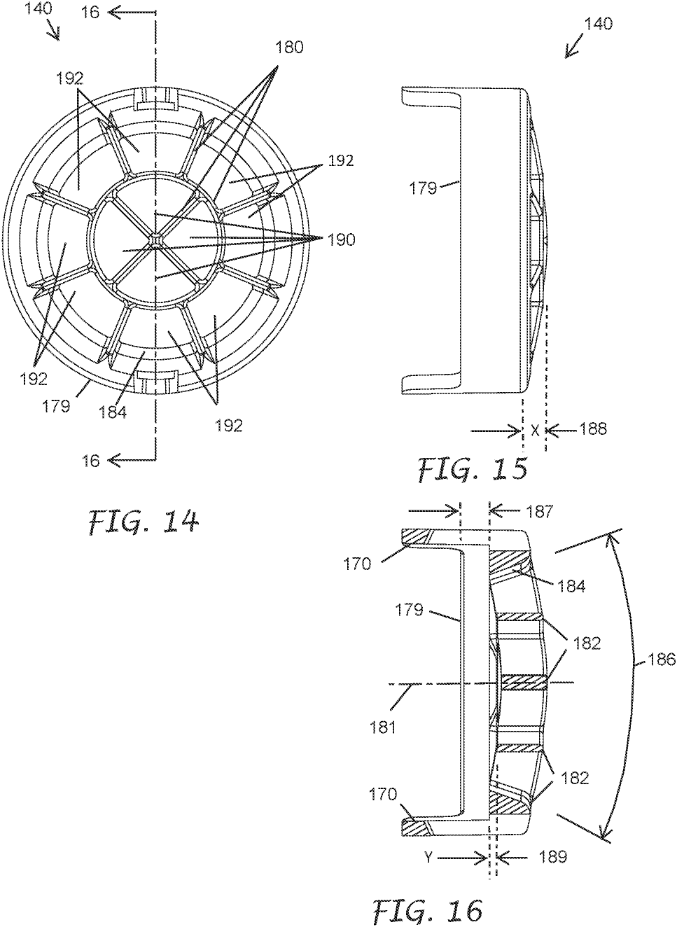

FIG. 14 is a front view of the stream conditioner 140 from FIG. 13. FIG. 15 is right side view of the stream conditioner 140 of FIG. 14. FIG. 16 is a section view of the stream conditioner 140 of FIG. 14 cut along the cut line 16-16 of FIG. 14. The stream conditioner 140 can include a body 179 which includes a plurality of fins 180. In certain embodiments, the body 179 can define one or more flow regions between the plurality of fins 180. In certain embodiments, a cross-sectional flow area of each of the one or more flow regions can increase, decrease and/or stay constant in a downstream direction parallel to the central axis 181. In certain embodiments, the plurality of fins 180 can be straight or curved. In certain embodiments, two or more fins 180 can intersect to form a corner of a flow region. In certain embodiments, an angle created by the intersection of the fins 180 is 90°. In certain embodiments, the angle created by the intersection of the fins 180 is less than or greater than 90°.

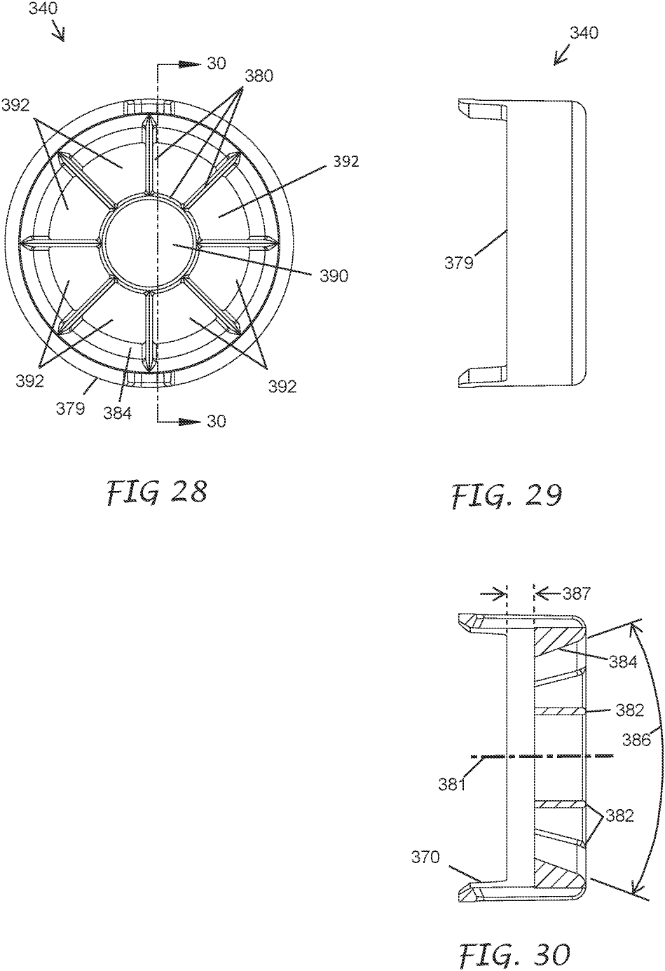

In certain embodiments, the body 179 can include a central flow region 190 and a perimeter flow region 192. In certain embodiments, a fin 180 having an annular shape defines the central flow region 190. In certain embodiments, the perimeter flow region 192 is defined between the central flow region 190 and an outer fin 180 formed as wall 184 of the stream conditioner 140. One or both of the central flow region 190 and the perimeter flow region 192 can be divided into two or more subregions by the plurality of fins 180. In this way, each of the subregions can be defined between one or more fins 180. For example, in certain embodiments, an outer perimeter of each of the subregions can be defined by one or more fins 180. In some embodiments, the fins 180 may be water-straightening fins. In certain embodiments, as illustrated in FIGS. 28-32, the fins 380 may be omitted in the central flow region 390.

In certain embodiments, a cross-sectional flow area of each of the subregions can increase, decrease and/or stay constant in a downstream direction parallel to the central axis 181. In certain embodiments, at least a portion of the outer perimeter of each of the subregions can taper or narrow in a downstream direction parallel to the central axis 181. For example, in certain embodiments, one of the fins 180 (e.g., fins and/or wall 184) forming a portion of the subregion tapers or narrows in a downstream direction parallel to the central axis 181. In other embodiments, two of the fins 180 (e.g., fins and/or wall 184) forming a portion of the subregion taper or narrow in a downstream direction parallel to the central axis 181. In other embodiments, more than two of the fins 180 (e.g., fins and/or wall 184) forming a portion of the subregion taper or narrow in a downstream direction parallel to the central axis 181.

In the illustrated embodiment, the central flow region 190 is divided into four subregions by the plurality of fins 180. In other embodiments, the central flow region 190 is divided into two, six, eight, or more subregions by the plurality of fins 180. In the illustrated embodiment, each of the four subregions has a constant cross-sectional flow area.

In the illustrated embodiment, the perimeter flow region 192 is divided into eight subregions by the plurality of fins 180. In other embodiments, the perimeter flow region 192 is divided into two, four, six, or more subregions by the plurality of fins 180. In the illustrated embodiment, each of the eight subregions has a decreasing cross-sectional flow area. The decrease in the cross-sectional flow area of the eight subregions is shown most clearly in FIG. 16 as reflected by angle 186. The angle 186 is defined by the wall 184. In some embodiments, the angle 186 of the wall 184 relative to the central axis 181 of the stream conditioner 140 is greater than 2°, greater than 4°, greater than 8°, greater than 13°, greater than 20°, and/or greater than 30°. In some cases, the angle 186 is approximately 5°. Many variations are possible.

As most clearly shown in FIG. 16, in certain embodiments, the stream conditioner 140 has a conical shape due to the inlet side being larger than the outlet side of the stream conditioner 140. In certain embodiments, this conical shape causes the water to accelerate before it enters the inlet of the primary nozzle 146. The higher velocity water entering the primary nozzle 146 can improve the performance of the primary nozzle 146.

In certain embodiments, the central flow stream 164 through the central flow region 190 can be substantially (e.g., within ±10°) parallel to the central axis 181 of the body 179 of the stream conditioner 140. In certain embodiments, the perimeter flow stream 162 through the perimeter flow region 192 can be angled (e.g., 10 to 45°) relative to the central axis 181 of the body 179 of the stream conditioner 140.

In certain embodiments, these structures work together to reduce turbulence in the stream of water entering the primary nozzle 146. The plurality of fins 180 can be configured to straighten water flow through the interior of the stream conditioner 140. Removing the turbulence from the water is important to increase the range that the water will reach after it leaves the primary nozzle 146.

In certain embodiments, the exit side of the stream conditioner 140 has a smaller diameter than the inlet side of the stream conditioner 140. In certain embodiments, the stream conditioner 140 straightens the water streams while its tapering shape within the one or more flow regions (e.g., water enters the stream conditioner 140 at a larger diameter, and exits the stream conditioner 140 at a smaller diameter) accelerates the water before it enters the primary nozzle 146. In certain embodiments, these structures, in combination, improve performance of the primary nozzle 146 by improving the efficiency of the primary nozzle 146. For example, in certain embodiments, these structures allow the sprinkler 100 to throw water at a greater radius than other sprinklers with the same inlet flow and pressure. For example, in certain embodiments, the pressure of the water entering the sprinkler 100 can be reduced as compared to sprinklers that do not have this combination of structures without reducing the resulting throw radius of the sprinkler.

In certain embodiments, one or more of the fins 176 in the primary nozzle 146 aligns with one or more of the fins 180 in the stream conditioner 140 (FIG. 12). In FIG. 12, eight of the fins 176 in the primary nozzle 146 align with eight of the fins 180 in the perimeter flow region 192 of the stream conditioner 140. In certain embodiments, a height of the fins 176 in the primary nozzle 146 tapers along the length of the fins 176 in a direction towards the stream conditioner 140.

As shown in FIG. 15, in certain embodiments, a portion of the fins 180 of the stream conditioner 140 can protrude a distance X 188 from an outer circumference of the body 179 in an upstream direction towards the chamber 160. In certain embodiments, the protruding fins 180 form a convex outer surface of the stream conditioner 140. In certain embodiments, a leading edge 182 of the fins 180 have a tapered shape.

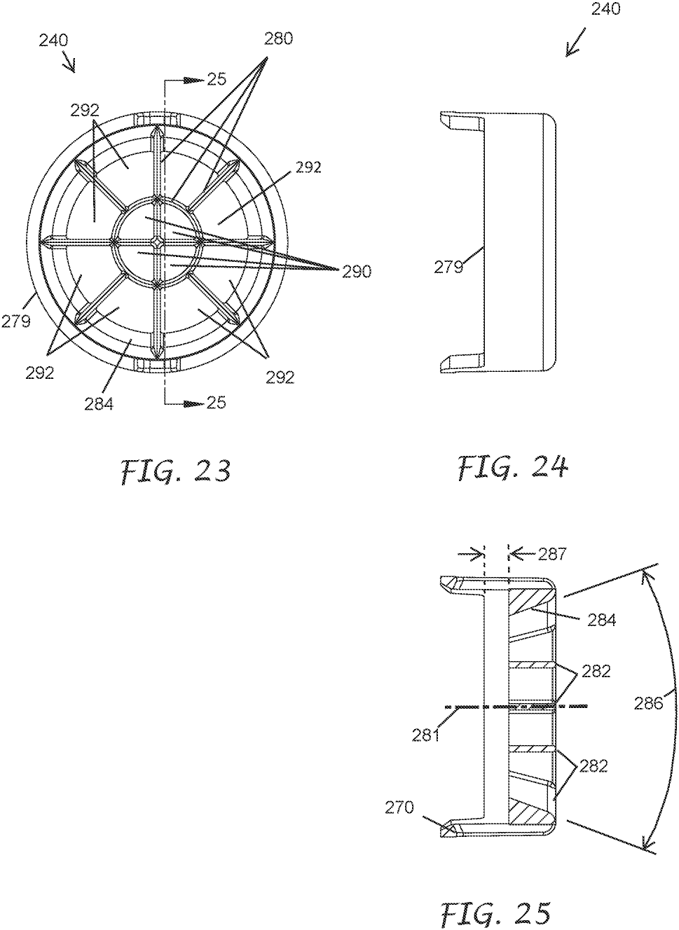

As shown in FIG. 16, in certain embodiments, a portion of the fins 180 of the stream conditioner 140 are recessed a distance Y 189 in an downstream direction towards the chamber 160. In certain embodiments, the recessed fins 180 form a concave inner surface of the stream conditioner 140. In certain embodiments, the concave inner surface is offset a fixed distance (e.g., height of the fins 180) from the concave outer surface. In certain embodiments, as best seen in FIGS. 23-32, the fins 280 do not protrude from an outer surface of the body 279 and instead form a flat outer surface of the stream conditioner 240.

Referring to FIG. 16, in certain embodiments, the body 179 of the stream conditioner 140 includes a skirt 187 sized and shaped to surround a portion of the primary nozzle 146. In certain embodiments, the primary nozzle 146 nests inside the skirt 187 of the body 179 when the primary nozzle 146 is installed in the turret 106.

In some embodiments, portions of the body 179 (e.g., the skirt 187) abut a surface of the turret 106 when the nozzle assembly 108 is mated with the nozzle recess 135 to prevent the stream conditioner 140 from being blown out of the outlet 107 if the nozzle assembly 108 becomes dislodged from the turret 106 when the sprinkler 100 is under pressure. The skirt 187, or some other portion of the body 179, can include one or more recesses, nubs, breaks, gaps, protrusions, or other structures configured to engage with the structure of the nozzle recess 135 to secure the stream conditioner 140 relative to the turret 106.

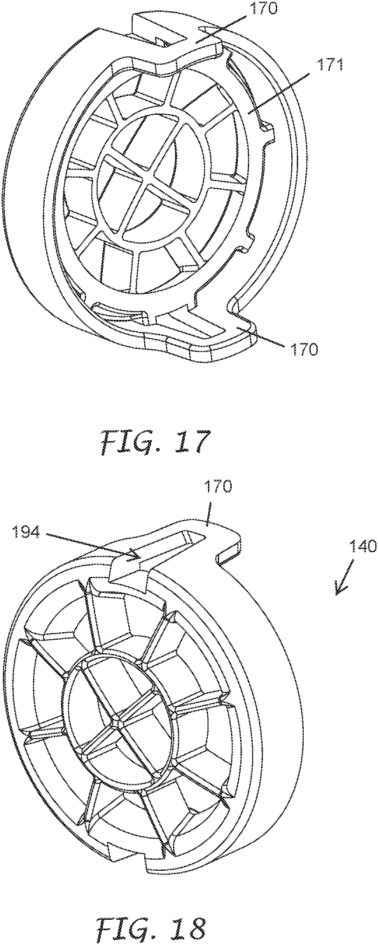

FIG. 17 is a back perspective view of the stream conditioner 140 of FIG. 14. FIG. 18 is a front perspective view of the stream conditioner 140 of FIG. 14. The fins 180 of the stream conditioner 140 can perform as an abutment structure to limit the extent to which the nozzle assembly 108 can be inserted into the turret 106. For example, the fins 180 can be positioned such that a back end of the primary nozzle 146 is disposed in the skirt 187 and abuts the fins 180. Abutment between the primary nozzle 146 and the fins 180 can reduce or eliminate movement of the nozzle assembly 108 with respect to the turret 106 when the nozzle system 108 is mated with the turret 106.

In some embodiments, a radial support structure 171 can be formed in the stream conditioner 140. In some embodiments, at least one of the fins 180 can extend from the support structure 171. In some embodiments, the support structure 171 can perform as an abutment structure to limit the extent to which the nozzle assembly 108 can be inserted into the turret 106. For example, the support structure 171 can be positioned such that a back end of the primary nozzle 146 is disposed in the skirt 187 and abuts the support structure 171. Abutment between the primary nozzle 146 and the support structure 171 can reduce or eliminate movement of the nozzle assembly 108 with respect to the turret 106 when the nozzle system 108 is mated with the turret 106.

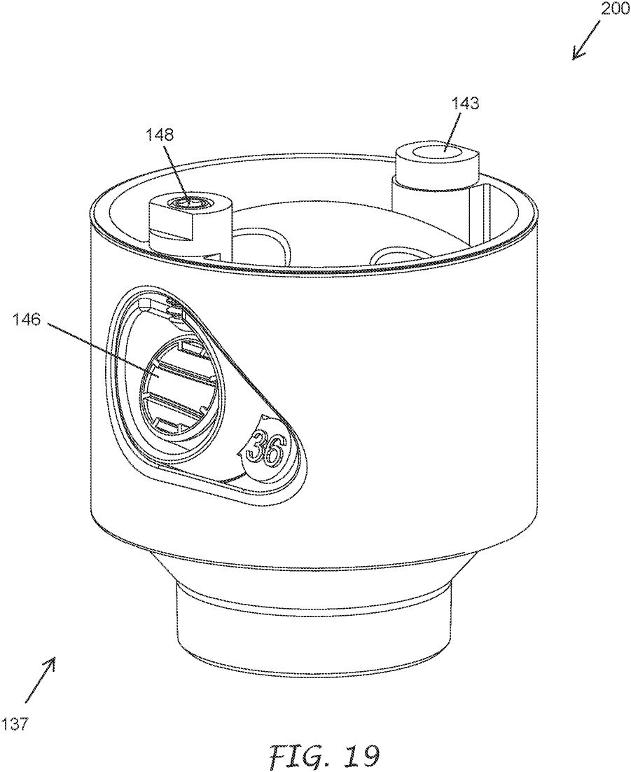

FIGS. 19-22 illustrate another embodiment of a turret 200. Many of the features of the turret 200 are the same as or similar to the features of the turret 106 discussed above. As such, like reference numbers are used for unchanged features between the turret 106 and the turret 200. FIG. 19 is a perspective view of the turret 200 which is similar to the turret 106 of FIG. 11 except the turret 200 of FIG. 19 includes a secondary nozzle 142, 144 on an opposite side of the turret 200 from the primary nozzle 146. In the illustrated embodiment, the secondary nozzle 142, 144 is 180 degrees away from the primary nozzle 146. Of course the disclosure is not limited to the illustrated embodiment. The turret 200 can include any number of nozzles which can be spaced at any location(s) around the circumference of the turret 200.

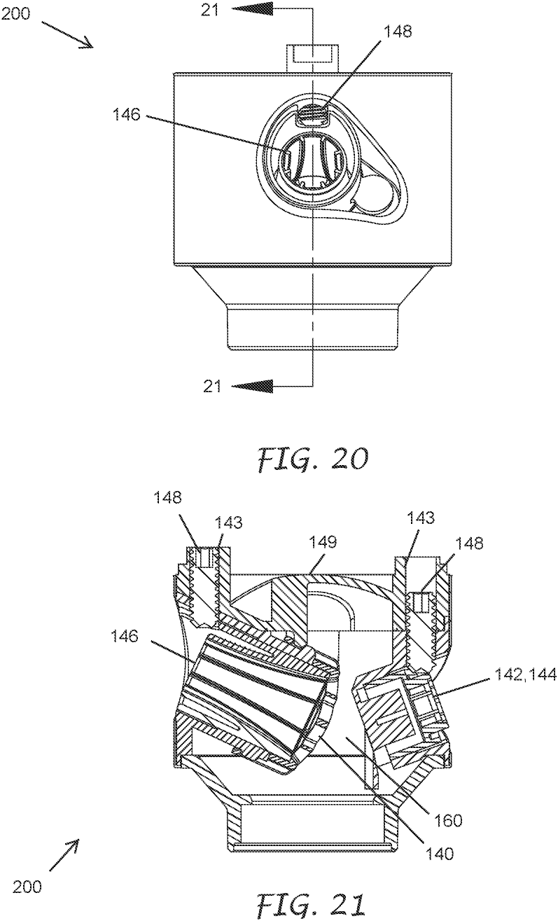

FIG. 20 is a front elevation view of the turret 200 of FIG. 19. FIG. 21 is a section view of the turret 200 of FIG. 19 cut along the cut line 21-21 of FIG. 20. In certain embodiments, the turret 200 includes one or more fasteners configured to secure the primary nozzle 146 and the secondary nozzle(s) 142, 144 to the turret housing 136. For example, the primary nozzle 146 can be secured by screw 148 (e.g., a set screw). The screw 148 can be inserted through a hole 143 through a portion (e.g., a top portion 154) of the turret 200 and through a groove or hole 145 in a portion of the primary nozzle 146 to lock the primary nozzle 146 to the turret housing 136. Similarly, for example, the secondary nozzle(s) 142, 144 can be secured by another screw 148 (e.g., a set screw). The screw 148 can be inserted through another hole 143 through a portion (e.g., a top portion 154) of the turret 200 and through a groove or hole 145 in a portion of the secondary nozzle(s) 142, 144 to lock the secondary nozzle(s) 142, 144 to the turret housing 136. In certain embodiments, the screws 148 engage with the primary nozzle 146 and the secondary nozzle(s) 142, 144 to prevent the water pressure in the turret 200 from ejecting the primary nozzle 146 and the secondary nozzle(s) 142, 144.

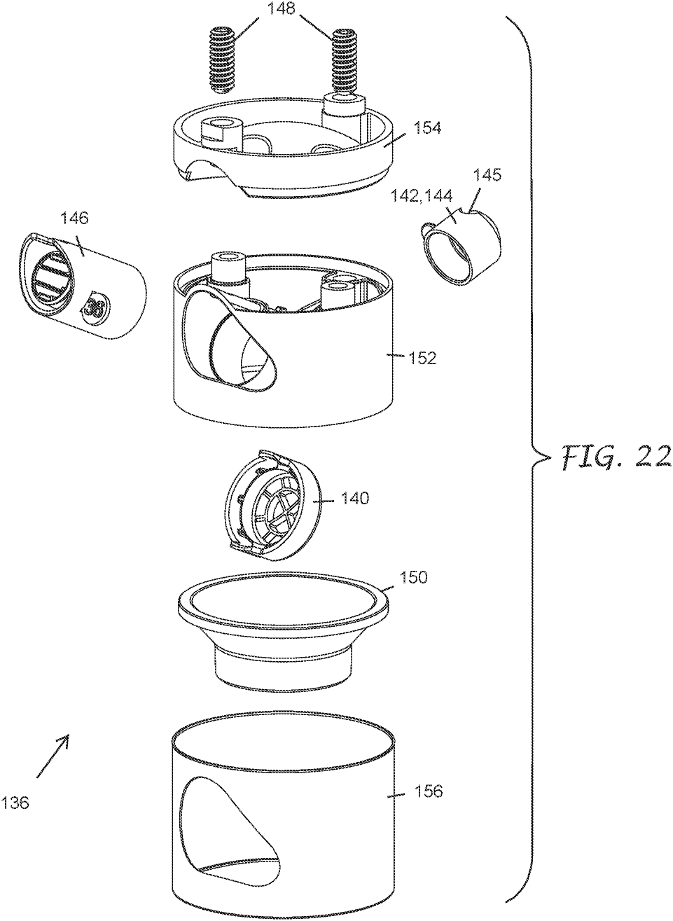

FIG. 22 is an exploded view of the turret 200 of FIG. 19. The turret housing 136 can include a turret inlet 147 in the base 150. The turret inlet 147 can be upstream from a chamber 160. The chamber 160 can include an upper wall 149 formed by a surface of the top portion 154. An inner surface on a body 152 of the turret 200 can form an outer wall of the chamber 160. In certain embodiments, the upper wall 149 inhibits or prevents passage of water past the primary nozzle 146 and the secondary nozzle(s) 142, 144 other than through the stream conditioner 140 or through the secondary nozzle(s) 142, 144. In some embodiments, turbulence within the base 150 and the chamber 160 is reduced, as all of the water contacting the stream conditioner 140 of the primary nozzle 146 is directed through the primary nozzle 146. Water enters the stream conditioner 140 from the chamber 160.

In certain embodiments, the turret housing 136 includes a sleeve 156. In certain embodiments, the sleeve 156 forms an outer support structure for the assembled turret housing 136. For example, the support structure of the sleeve 156 can resist hoop or circumferential stresses created by pressurized water in the chamber 160. In certain embodiments, the sleeve 156 surrounds an outer perimeter of the top portion 154, the body 152, and/or the base 150. In certain embodiments, the sleeve 156 is made from stainless steel. In certain embodiments, the sleeve 156 can provide a hard smooth surface to improve aesthetics. In certain embodiments, the sleeve 156 can provide a hard smooth surface to provide wear resistance that is greater than plastic, especially when the turret 106 retracts into the outer body 102 or the body cap 128.

The turret 200 can be used with a sprinkler that is configured to rotate in a full circle by continuously rotating in a single direction. As is illustrated in FIG. 21, the primary nozzle 146 is disposed on a first side of the turret 200 while the secondary nozzle(s) 142, 144 is disposed on the opposite side of the turret 200. As is illustrated in FIG. 21, the stream conditioner 140 is only associated with the primary nozzle 146. Of course, the disclosure is not limited to only having a stream conditioner 140 associated with the primary nozzle 146. In other embodiments, a stream conditioner 140 is associated with each nozzle.

FIG. 23 is a front view of another embodiment of a stream conditioner 240 that has a flat input side. In contrast to the fins 180 of the stream conditioner 140 (FIG. 16), the fins 280 of the stream conditioner 240 do not protrude from an outer circumference of the body 279 in an upstream direction towards the chamber 160.

FIG. 24 is right side view of the stream conditioner 240 of FIG. 23. FIG. 25 is a section view of the stream conditioner 240 of FIG. 23 cut along the cut line 25-25 of FIG. 23. The stream conditioner 240 can include a body 279 which includes a plurality of fins 280. In certain embodiments, the body 279 can define one or more flow regions between the plurality of fins 280. In certain embodiments, a cross-sectional flow area of each of the one or more flow regions can increase, decrease and/or stay constant in a downstream direction parallel to the central axis 281. In certain embodiments, the plurality of fins 280 can be straight or curved. In certain embodiments, two or more fins 280 can intersect to form a corner of a flow region. In certain embodiments, an angle created by the intersection of the fins 280 is 90°. In certain embodiments, the angle created by the intersection of the fins 280 is less than or greater than 90°.

In certain embodiments, the body 279 can include a central flow region 290 and a perimeter flow region 292. In certain embodiments, a fin 280 having an annular shape defines the central flow region 290. In certain embodiments, the perimeter flow region 292 is defined between the central flow region 290 and an outer fin 280 formed as wall 284 of the stream conditioner 240. One or both of the central flow region 290 and the perimeter flow region 292 can be divided into two or more subregions by the plurality of fins 280. In this way, each of the subregions can be defined between one or more fins 280. For example, in certain embodiments, an outer perimeter of each of the subregions can be defined by one or more fins 280. In some embodiments, the fins 280 may be water-straightening fins.

In certain embodiments, a cross-sectional flow area of each of the subregions can increase, decrease and/or stay constant in a downstream direction parallel to the central axis 281. In certain embodiments, at least a portion of the outer perimeter of each of the subregions can taper or narrow in a downstream direction parallel to the central axis 281. For example, in certain embodiments, one of the fins 280 (e.g., fins 280 and/or wall 284) forming a portion of the subregion tapers or narrows in a downstream direction parallel to the central axis 281. In other embodiments, two of the fins 280 (e.g., fins 280 and/or wall 284) forming a portion of the subregion taper or narrow in a downstream direction parallel to the central axis 281. In other embodiments, more than two of the fins 280 (e.g., fins 280 and/or wall 284) forming a portion of the subregion taper or narrow in a downstream direction parallel to the central axis 281.

In the illustrated embodiment, the central flow region 290 is divided into four subregions by the plurality of fins 280. In other embodiments, the central flow region 290 is divided into two, six, eight, or more subregions by the plurality of fins 280. In the illustrated embodiment, each of the four subregions has a constant cross-sectional flow area. In other embodiments, the central flow region 290 tapers or narrows in a downstream direction parallel to the central axis 281.

In the illustrated embodiment, the perimeter flow region 292 is divided into eight subregions by the plurality of fins 280. In other embodiments, the perimeter flow region 292 is divided into two, four, six, or more subregions by the plurality of fins 280. In the illustrated embodiment, each of the eight subregions has a decreasing cross-sectional flow area. The decrease in the cross-sectional flow area of the eight subregions is shown most clearly in FIG. 25 as reflected by angle 286. The angle 286 is defined by the wall 284. In some embodiments, the angle 286 of the wall 284 relative to the central axis 281 of the stream conditioner 240 is greater than 2°, greater than 4°, greater than 8°, greater than 13°, greater than 20°, and/or greater than 30°. In some cases, the angle 286 is approximately 5°. Many variations are possible.

As most clearly shown in FIG. 25, in certain embodiments, the stream conditioner 240 has a conical shape due to the inlet side being larger than the outlet side of the stream conditioner 240. In certain embodiments, this conical shape causes the water to accelerate before it enters the inlet of the primary nozzle 146. The higher velocity water entering the primary nozzle 146 can improve the performance of the primary nozzle 146.

In certain embodiments, the central flow stream 164 (FIG. 10) through the central flow region 290 can be substantially (e.g., within ±10°) parallel to the central axis 281 of the body 279 of the stream conditioner 240. In certain embodiments, the perimeter flow stream 162 through the perimeter flow region 292 can be angled (e.g., 10 to 45°) relative to the central axis 281 of the body 279 of the stream conditioner 240.

In certain embodiments, these structures work together to reduce turbulence in the stream of water entering the primary nozzle 146. The plurality of fins 280 can be configured to straighten water flow through the interior of the stream conditioner 240. Removing the turbulence from the water is important to increase the range that the water will reach after it leaves the primary nozzle 146.

In certain embodiments, the exit side of the stream conditioner 240 has a smaller diameter than the inlet side of the stream conditioner 240. In certain embodiments, the stream conditioner 240 straightens the water streams while its tapering shape within the one or more flow regions (e.g., water enters the stream conditioner 240 at a larger diameter, and exits the stream conditioner 240 at a smaller diameter) accelerates the water before it enters the primary nozzle 146. In certain embodiments, these structures, in combination, improve performance of the primary nozzle 146 by improving the efficiency of the primary nozzle 146. For example, in certain embodiments, these structures allow the sprinkler 100 to throw water at a greater radius than other sprinklers with the same inlet flow and pressure. For example, in certain embodiments, the pressure of the water entering the sprinkler 100 can be reduced as compared to sprinklers that do not have this combination of structures without reducing the resulting throw radius of the sprinkler.

In certain embodiments, one or more of the fins 176 in the primary nozzle 146 aligns with one or more of the fins 280 in the stream conditioner 240 (FIG. 12). In FIG. 12, eight of the fins 176 in the primary nozzle 146 align with eight of the fins 180, 280 in the perimeter flow region 191, 292 of the stream conditioner 140, 240. In certain embodiments, a height of the fins 176 in the primary nozzle 146 tapers along the length of the fins 176 in a direction towards the stream conditioner 140, 240.

Referring to FIG. 25, in certain embodiments, the body 279 of the stream conditioner 240 includes a skirt 287 sized and shaped to surround a portion of the primary nozzle 146. In certain embodiments, the primary nozzle 146 nests inside the skirt 287 of the body 279 when the primary nozzle 146 is installed in the turret 106.

In some embodiments, portions of the body 279 (e.g., the skirt 287) abut a surface of the turret 106 when the nozzle assembly 108 is mated with the nozzle recess 135 to prevent the stream conditioner 240 from being blown out of the outlet 107 if the nozzle assembly 108 becomes dislodged from the turret 106 when the sprinkler 100 is under pressure. The skirt 287, or some other portion of the body 279, can include one or more recesses, nubs, breaks, gaps, protrusions, or other structures configured to engage with the structure of the nozzle recess 135 to secure the stream conditioner 240 relative to the turret 106.

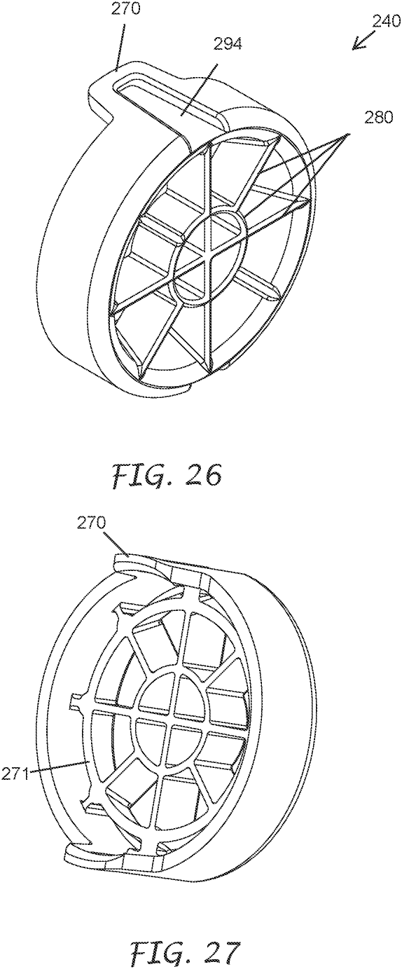

FIG. 26 is a front perspective view of the stream conditioner 240 of FIG. 23. FIG. 27 is a back perspective view of the stream conditioner 240 of FIG. 23. The fins 280 of the stream conditioner 240 can perform as an abutment structure to limit the extent to which the nozzle assembly 108 can be inserted into the turret 106. For example, the fins 280 can be positioned such that a back end of the primary nozzle 146 is disposed in the skirt 287 and abuts the fins 280. Abutment between the primary nozzle 146 and the fins 280 can reduce or eliminate movement of the nozzle assembly 108 with respect to the turret 106 when the nozzle system 108 is mated with the turret 106.

In some embodiments, a radial support structure 271 can be formed in the stream conditioner 240. In some embodiments, at least one of the fins 280 can extend from the support structure 271. In some embodiments, the support structure 271 can perform as an abutment structure to limit the extent to which the nozzle assembly 108 can be inserted into the turret 106. For example, the support structure 271 can be positioned such that a back end of the primary nozzle 146 is disposed in the skirt 287 and abuts the support structure 271. Abutment between the primary nozzle 146 and the support structure 271 can reduce or eliminate movement of the nozzle assembly 108 with respect to the turret 106 when the nozzle system 108 is mated with the turret 106.

FIG. 28 is a front view of another embodiment of a stream conditioner 340 that has a flat input side and an open central flow region 390. In contrast to the central flow region 290 of the stream conditioner 240 (FIG. 23), the central flow region 390 of the stream conditioner 340 is not divided into subregions.

FIG. 29 is right side view of the stream conditioner 340 of FIG. 28. FIG. 30 is a section view of the stream conditioner 340 of FIG. 28 cut along the cut line 30-30 of FIG. 28. The stream conditioner 340 can include a body 379 which includes a plurality of fins 380. In certain embodiments, the body 379 can define one or more flow regions between the plurality of fins 380. In certain embodiments, a cross-sectional flow area of each of the one or more flow regions can increase, decrease and/or stay constant in a downstream direction parallel to the central axis 381. In certain embodiments, the plurality of fins 380 can be straight or curved. In certain embodiments, two or more fins 380 can intersect to form a corner of a flow region. In certain embodiments, an angle created by the intersection of the fins 380 is 90°. In certain embodiments, the angle created by the intersection of the fins 380 is less than or greater than 90°.

In certain embodiments, the body 379 can include a central flow region 390 and a perimeter flow region 392. In certain embodiments, a fin 380 having an annular shape defines the central flow region 390. In certain embodiments, the perimeter flow region 392 is defined between the central flow region 390 and an outer fin 380 formed as wall 384 of the stream conditioner 340. One or both of the central flow region 390 and the perimeter flow region 392 can be divided into two or more subregions by the plurality of fins 380. In the embodiment illustrated in FIGS. 28-32, only the perimeter flow region 392 is divided into subregions. In this way, each of the subregions of the perimeter flow region 392 can be defined between one or more fins 380. In some embodiments, the fins 380 may be water-straightening fins.

In the embodiment illustrated in FIGS. 28-32, a cross-sectional flow area of each of the subregions of the perimeter flow region 392 can increase, decrease and/or stay constant in a downstream direction parallel to the central axis 381. In certain embodiments, at least a portion of the outer perimeter of each of the subregions can taper or narrow in a downstream direction parallel to the central axis 381. For example, in certain embodiments, one of the fins 380 (e.g., fins 380 and/or wall 384) forming a portion of the subregion tapers or narrows in a downstream direction parallel to the central axis 381. In other embodiments, two of the fins 380 (e.g., fins 380 and/or wall 384) forming a portion of the subregion taper or narrow in a downstream direction parallel to the central axis 381. In other embodiments, more than two of the fins 380 (e.g., fins 380 and/or wall 384) forming a portion of the subregion taper or narrow in a downstream direction parallel to the central axis 381.

In the embodiment illustrated in FIGS. 28-32, the central flow region 390 has a constant cross-sectional flow area. In other embodiments, the central flow region 390 tapers or narrows in a downstream direction parallel to the central axis 381.

In the illustrated embodiment, the perimeter flow region 392 is divided into eight subregions by the plurality of fins 380. In other embodiments, the perimeter flow region 392 is divided into two, four, six, or more subregions by the plurality of fins 380. In the illustrated embodiment, each of the eight subregions has a decreasing cross-sectional flow area. The decrease in the cross-sectional flow area of the eight subregions is shown most clearly in FIG. 30 as reflected by angle 386. The angle 386 is defined by the wall 384. In some embodiments, the angle 386 of the wall 384 relative to the central axis 381 of the stream conditioner 340 is greater than 2°, greater than 4°, greater than 8°, greater than 13°, greater than 20°, and/or greater than 30°. In some cases, the angle 286 is approximately 5°. Many variations are possible.

As most clearly shown in FIG. 30, in certain embodiments, the stream conditioner 340 has a conical shape due to the inlet side being larger than the outlet side of the stream conditioner 340. In certain embodiments, this conical shape causes the water to accelerate before it enters the inlet of the primary nozzle 146. The higher velocity water entering the primary nozzle 146 can improve the performance of the primary nozzle 146.

In certain embodiments, the central flow stream 164 (FIG. 10) through the central flow region 390 can be substantially (e.g., within ±10°) parallel to the central axis 381 of the body 379 of the stream conditioner 340. In certain embodiments, the perimeter flow stream 162 through the perimeter flow region 392 can be angled (e.g., 10 to 45°) relative to the central axis 381 of the body 379 of the stream conditioner 340.

In certain embodiments, these structures work together to reduce turbulence in the stream of water entering the primary nozzle 146. The plurality of fins 380 can be configured to straighten water flow through the interior of the stream conditioner 340. Removing the turbulence from the water is important to increase the range that the water will reach after it leaves the primary nozzle 146.

In certain embodiments, the exit side of the stream conditioner 340 has a smaller diameter than the inlet side of the stream conditioner 340. In certain embodiments, the stream conditioner 340 straightens the water streams while its tapering shape within the one or more flow regions (e.g., water enters the stream conditioner 340 at a larger diameter, and exits the stream conditioner 340 at a smaller diameter) accelerates the water before it enters the primary nozzle 146. In certain embodiments, these structures, in combination, improve performance of the primary nozzle 146 by improving the efficiency of the primary nozzle 146. For example, in certain embodiments, these structures allow the sprinkler 100 to throw water at a greater radius than other sprinklers with the same inlet flow and pressure. For example, in certain embodiments, the pressure of the water entering the sprinkler 100 can be reduced as compared to sprinklers that do not have this combination of structures without reducing the resulting throw radius of the sprinkler.

In certain embodiments, one or more of the fins 176 in the primary nozzle 146 aligns with one or more of the fins 380 in the stream conditioner 340 (FIG. 12). In FIG. 12, eight of the fins 176 in the primary nozzle 146 align with eight of the fins 180, 280, 380 in the perimeter flow region 191, 292, 392 of the stream conditioner 140, 240, 340. In certain embodiments, a height of the fins 176 in the primary nozzle 146 tapers along the length of the fins 176 in a direction towards the stream conditioner 140, 240, 340.

Referring to FIG. 30, in certain embodiments, the body 379 of the stream conditioner 340 includes a skirt 387 sized and shaped to surround a portion of the primary nozzle 146. In certain embodiments, the primary nozzle 146 nests inside the skirt 387 of the body 379 when the primary nozzle 146 is installed in the turret 106.

In some embodiments, portions of the body 379 (e.g., the skirt 387) abut a surface of the turret 106 when the nozzle assembly 108 is mated with the nozzle recess 135 to prevent the stream conditioner 340 from being blown out of the outlet 107 if the nozzle assembly 108 becomes dislodged from the turret 106 when the sprinkler 100 is under pressure. The skirt 387, or some other portion of the body 379, can include one or more recesses, nubs, breaks, gaps, protrusions, or other structures configured to engage with the structure of the nozzle recess 135 to secure the stream conditioner 340 relative to the turret 106.

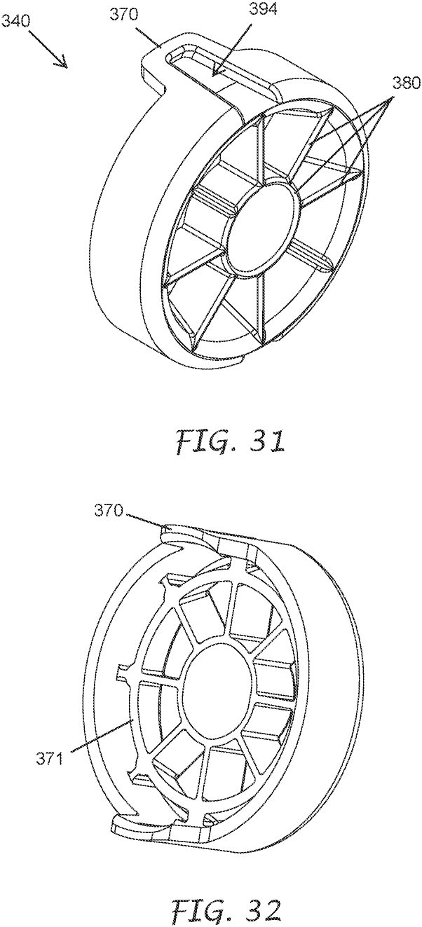

FIG. 31 is a front perspective view of the stream conditioner 340 of FIG. 28. FIG. 32 is a back perspective view of the stream conditioner 340 of FIG. 28. The fins 380 of the stream conditioner 340 can perform as an abutment structure to limit the extent to which the nozzle assembly 108 can be inserted into the turret 106. For example, the fins 380 can be positioned such that a back end of the primary nozzle 146 is disposed in the skirt 387 and abuts the fins 380. Abutment between the primary nozzle 146 and the fins 380 can reduce or eliminate movement of the nozzle assembly 108 with respect to the turret 106 when the nozzle system 108 is mated with the turret 106.

In some embodiments, a radial support structure 371 can be formed in the stream conditioner 340. In some embodiments, at least one of the fins 380 can extend from the support structure 371. In some embodiments, the support structure 371 can perform as an abutment structure to limit the extent to which the nozzle assembly 108 can be inserted into the turret 106. For example, the support structure 371 can be positioned such that a back end of the primary nozzle 146 is disposed in the skirt 387 and abuts the support structure 371. Abutment between the primary nozzle 146 and the support structure 371 can reduce or eliminate movement of the nozzle assembly 108 with respect to the turret 106 when the nozzle system 108 is mated with the turret 106.

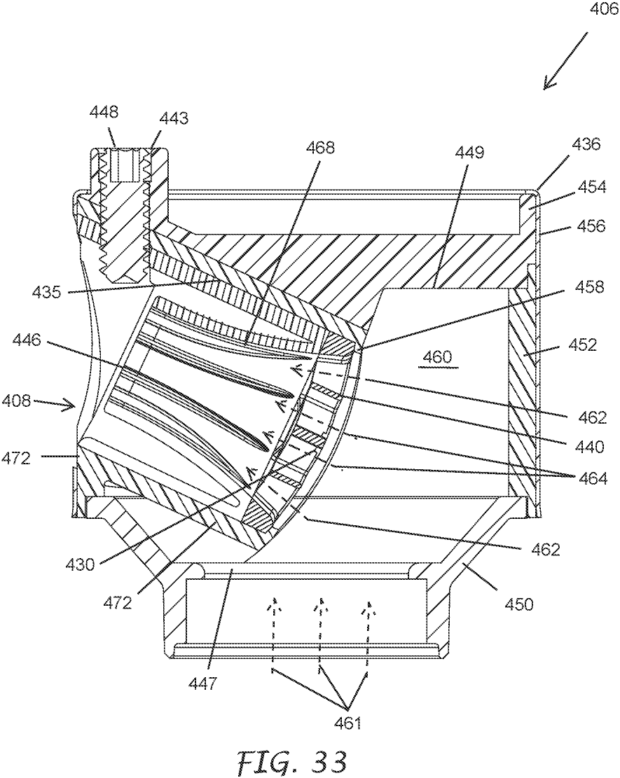

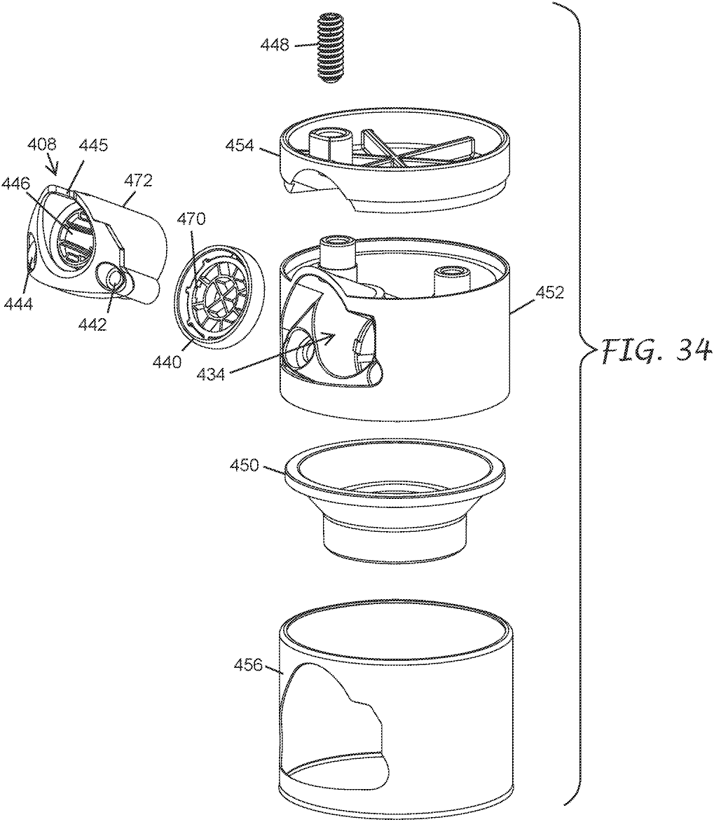

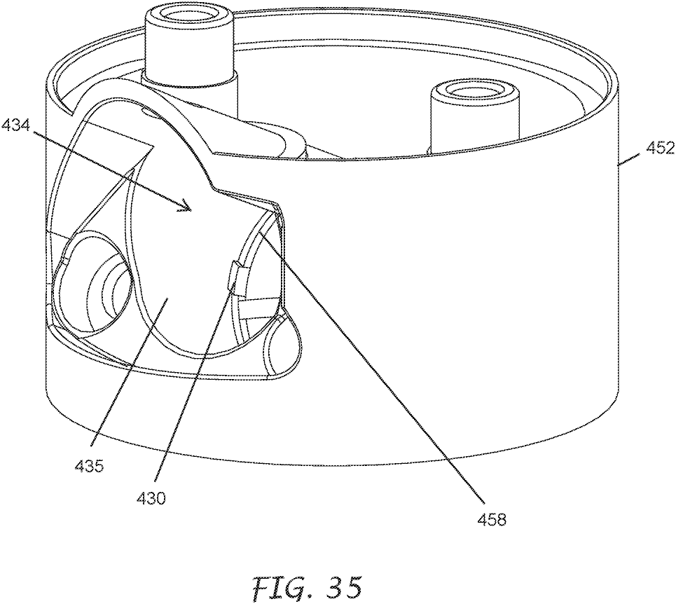

FIG. 33 is a section view of another embodiment of a turret 406 similar to the turret 106 of FIG. 9 except the stream conditioner 440 of FIG. 33 is disposed inside a nozzle port upstream of a nozzle. In the illustrated embodiment, the stream conditioner 440 is disposed inside a primary port 434 of the turret 406 (see FIG. 34). The turret 406 can share similar or identical features with the turret 106 except the stream conditioner 440 can be installed into the primary port 434 upstream of the primary nozzle 446 instead of being installed in the chamber 160 in the turret 106. In certain embodiments, the turret 406 can be installed on the sprinkler 100 in place of the turret 106.

In certain embodiments, at least a portion of the stream conditioner 440 can be positioned in a nozzle recess 435 within the nozzle assembly 408. In certain embodiments, a flange 458 is formed at the upstream end of the nozzle recess 435. In certain embodiments, the flange 458 is sized and shaped to prevent the stream conditioner 440 from passing entirely through the nozzle recess 435 and into the chamber 460. In certain embodiments, the stream conditioner 440 can be positioned at the furthermost upstream end of the nozzle recess 435 against the flange 458. In certain embodiments, the stream conditioner 440 can be press fit into the nozzle recess 435. In certain embodiments, the stream conditioner 440 can be removeable inserted into the nozzle recess 435. In some instances, the stream conditioner 440 can be retained in the nozzle recess 435 by the nozzle assembly 408.

The nozzle recess 435 can be sized and shaped to receive the primary nozzle 446 of the nozzle assembly 408. A cylindrical base of the primary nozzle 446 can be inserted in the primary port 434 thus, the primary port 434 can function as a socket for removably receiving at least a portion of the nozzle assembly 408 and the stream conditioner 440.

The primary nozzle 446 can include a tapered portion 468. The tapered portion 468 can define an inlet to the primary nozzle 446 from the stream conditioner 440. In certain embodiments, the tapered portion 468 is connected to a shroud 472. In certain embodiments, the shroud 472 extends around the nozzle assembly 408. The shroud 472 can overlap at least a portion of the tapered portion 468. In some embodiments, the shape of the shroud 472 defines a shape of an outer perimeter of the nozzle assembly 408. In some embodiments, the tapered portion 468 is connected to and/or extends from a front end of the shroud 472 in the region of the primary nozzle 446.

In certain embodiments, the turret 406 includes one or more fasteners configured to secure the nozzle assembly 408 to the turret housing 436. For example, the nozzle assembly 408 can include a screw 448 (e.g., a set screw). The screw 448 can be inserted through a hole 443 through a portion (e.g., a top portion 454) of the turret 406 and through a groove or hole 445 in a portion of the nozzle assembly 408 to lock the nozzle assembly 408 to the turret housing 436. In certain embodiments, the screw 448 engages with the nozzle assembly 408 to prevent the water pressure in the turret 406 from ejecting the nozzle assembly 408.

An inner surface on a body 452 of the turret 406 can form an outer wall of the chamber 460. In certain embodiments, the upper wall 449 inhibits or prevents passage of water past the nozzle assembly 408 other than through the stream conditioner 440 or through the first and second secondary nozzles 442, 444. In certain embodiments, turbulence within the base 450 and the chamber 460 is reduced, as all of the water contacting the stream conditioner 440 is directed through the primary nozzle 446. In certain embodiments, water enters the stream conditioner 440 from the chamber 460.

FIG. 33 shows a plurality of flow streams passing through the stream conditioner 440 including one or more central flow streams 464 and one or more perimeter flow streams 462. In certain embodiments, as water 461 is flowing in the turret 406, there is turbulence in the water. The stream conditioner 440 reduces the turbulence and straightens the flow path to better direct the water into the inlet side of the primary nozzle 446 improving performance of the primary nozzle 446. In certain embodiments, the stream conditioner 440 is shaped to accelerate the water passing through the stream conditioner 440. For example, in certain embodiments, the shape of the walls forming the one or more perimeter flow streams 462 accelerates the water 461 before the water 461 enters the primary nozzle 446 in the primary port 434. Other than the location within the turret housing 436, the stream conditioner 440 reduces turbulence and accelerates the water 461 flowing through the stream conditioner 440 as described above with respect to the stream conditioner 140.

FIG. 34 is an exploded view of the turret 406 of FIG. 33. In certain embodiments, the turret housing 436 includes a sleeve 456. In certain embodiments, the sleeve 456 forms an outer support structure for the assembled turret housing 436. For example, the support structure of the sleeve 156 can resist hoop or circumferential stresses created by pressurized water in the chamber 460. In certain embodiments, the sleeve 456 surrounds an outer perimeter of the top portion 454, the body 452, and/or the base 450. In certain embodiments, the sleeve 456 is made from stainless steel. In certain embodiments, the sleeve 456 can provide a hard smooth surface to improve aesthetics. In certain embodiments, the sleeve 456 can provide a hard smooth surface to provide wear resistance that is greater than plastic, especially when the turret 406 retracts into the outer body 102 or the body cap 128.

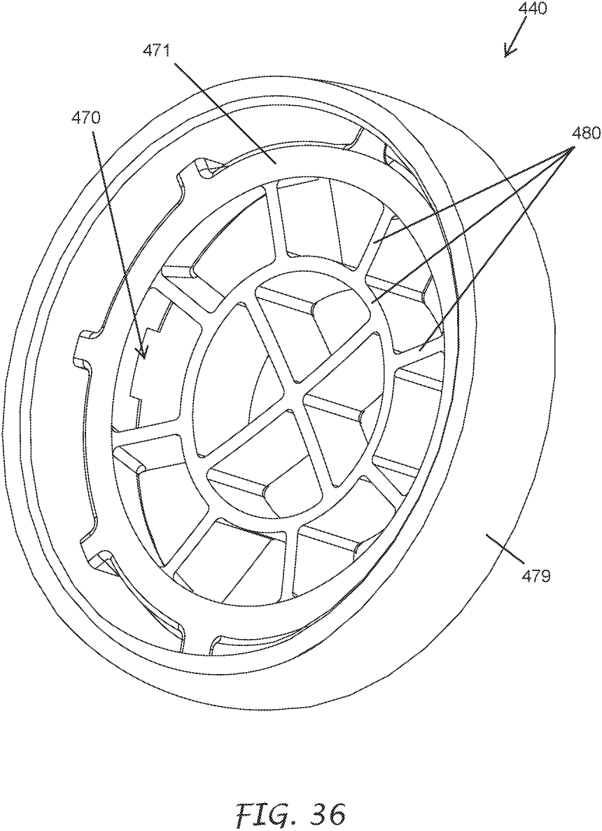

FIG. 35 is a perspective view of the body 452 from FIG. 34. FIG. 36 is an isometric view of the stream conditioner 440 of FIG. 34. The stream conditioner 440 can include a body 479 which has a plurality of fins 480. In certain embodiments, the body 479 can define one or more flow regions between the plurality of fins 480.

In certain embodiments, the stream conditioner 440 has a generally cylindrical configuration. In other embodiments, the shape of the stream conditioner 440 can be square, oval, rectangular, or any other shape. In certain embodiments, the stream conditioner 440 includes a structure (e.g., detents, protrusions, notches, bosses, or other alignment structures) that serves as an engagement structure 470. In the illustrated embodiment of FIG. 36, the engagement structure 470 is in the form of one or more notches. In certain embodiments, the engagement structure 470 aligns the stream conditioner 440 to the turret 406 or the primary nozzle 446.

In certain embodiments, the engagement structure 470 engages with the turret 406 so as to limit rotation of the stream conditioner 440 relative to the turret 406. In certain embodiments, rotation and or alignment of the stream conditioner 440 can depend on, for example, the relative sizes, shapes, and positioning of the engagement structures. In certain embodiments, the stream conditioner 440 can be rotated for less than 360 degrees about its axis 481 after being installed in the turret 406. In certain embodiments, the stream conditioner 440 can be rotated for less than 180 degrees about its axis 481 after being installed in the turret 406. In certain embodiments, the stream conditioner 440 can be rotated for less than 5 degrees about its axis 481 after being installed in the turret 406. In certain embodiments, the stream conditioner 440 is prevented from rotating about its axis 481 after being installed in the turret 406.

Each of the engagement structures 470 on the stream conditioner 440 can be configured to engage a complementary engagement structure 430 of the turret 406. For example, in certain embodiments, the turret 406 includes a structure (e.g., detents, protrusions, notches, bosses, or other alignment structures) that serves as a complementary engagement structure 430 to the engagement structure 470 of the stream conditioner 440. In the illustrated embodiment of FIG. 35, the engagement structure 430 is in the form of one or more alignment bosses configured to engage with the one or more notches of the stream conditioner 440.

In certain embodiments, the engagement structure 430 of the turret 406 aligns the stream conditioner 440 to the turret 406. For example, as illustrated, the turret 406 can include one engagement structure 430. In certain embodiments, the turret 406 can comprise a plurality of engagement structures 430. For example, in certain embodiments, two engagement structures 430 can be positioned 180° from each other around a perimeter of the nozzle recess 435. In certain embodiments, employing two engagement structures 470 on the stream conditioner 440 and two engagement structures 430 on the turret 406 as described above can facilitate mating of the stream conditioner 440 with the turret 406 in two rotational orientations, 180° apart rotationally. In certain embodiments, each of the engagement structures 470 are sized and shaped to engage with the engagement structures 430. When engaged, the one or more engagement structures 470 can prevent the stream conditioner 440 from rotating within the nozzle recess 435 and out of a desired orientation.

In some embodiments, a radial support structure 471 can be formed in the stream conditioner 440. In some embodiments, the support structure 471 can perform as an abutment structure to limit the extent to which the nozzle assembly 408 can be inserted into the turret 406. Abutment between the primary nozzle 446 and the support structure 471 can reduce or eliminate movement of the nozzle assembly 408 with respect to the turret 406 when the nozzle assembly 408 is mated with the turret 406.

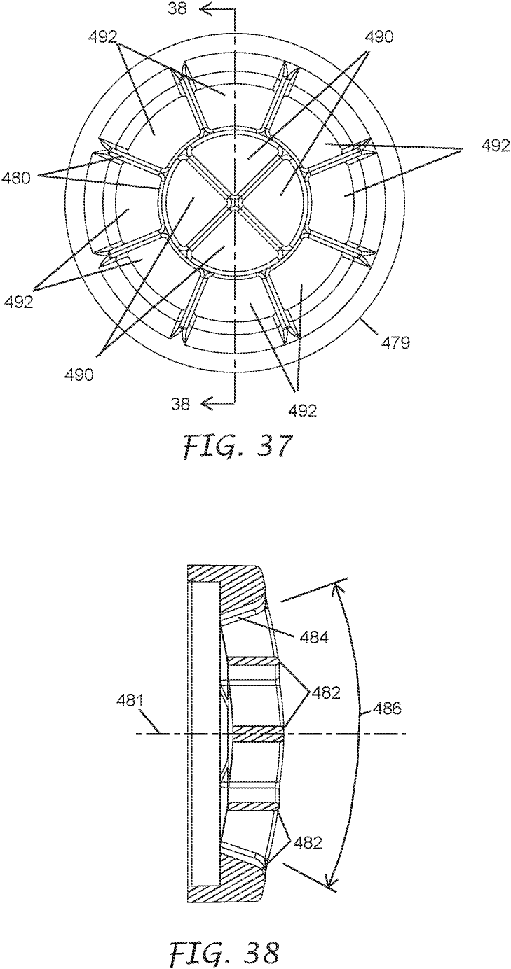

FIG. 37 is a back view of the stream conditioner 440 from FIG. 34. FIG. 38 is a section view of the stream conditioner 440 of FIG. 34 cut along the cut line 38-38 of FIG. 37. In certain embodiments, the body 479 can define one or more flow regions between the plurality of fins 480. In certain embodiments, a cross-sectional flow area of each of the one or more flow regions can increase, decrease and/or stay constant in a downstream direction parallel to the central axis 481. In certain embodiments, the plurality of fins 480 can be straight or curved. In certain embodiments, two or more fins 480 can intersect to form a corner of a flow region. In certain embodiments, an angle created by the intersection of the fins 480 is 90°. In certain embodiments, the angle created by the intersection of the fins 480 is less than or greater than 90°.

In certain embodiments, the body 479 can include a central flow region 490 and a perimeter flow region 492. In certain embodiments, a fin 480 having an annular shape defines the central flow region 490. In certain embodiments, the perimeter flow region 492 is defined between the central flow region 490 and an outer fin 480 formed as wall 484 of the stream conditioner 440. One or both of the central flow region 490 and the perimeter flow region 492 can be divided into two or more subregions by the plurality of fins 480. In this way, each of the subregions can be defined between one or more fins 480. For example, in certain embodiments, an outer perimeter of each of the subregions can be defined by one or more fins 480. In some embodiments, the fins 480 may be water-straightening fins.

In certain embodiments, a cross-sectional flow area of each of the subregions can increase, decrease and/or stay constant in a downstream direction parallel to the central axis 481. In certain embodiments, at least a portion of the outer perimeter of each of the subregions can taper or narrow in a downstream direction parallel to the central axis 481. For example, in certain embodiments, one of the fins 480 (e.g., fins and/or wall 484) forming a portion of the subregion tapers or narrows in a downstream direction parallel to the central axis 481. In other embodiments, two of the fins 480 (e.g., fins and/or wall 484) forming a portion of the subregion taper or narrow in a downstream direction parallel to the central axis 481. In other embodiments, more than two of the fins 480 (e.g., fins and/or wall 484) forming a portion of the subregion taper or narrow in a downstream direction parallel to the central axis 481. In certain embodiments, a leading edge 482 of the fins 480 have a tapered shape.

In the illustrated embodiment, the central flow region 490 is divided into four subregions by the plurality of fins 480. In other embodiments, the central flow region 490 is divided into two, six, eight, or more subregions by the plurality of fins 480. In some embodiments, the central flow region 490 is not divided by any fins 480. In the illustrated embodiment, each of the four subregions has a constant cross-sectional flow area.

In the illustrated embodiment, the perimeter flow region 492 is divided into eight subregions by the plurality of fins 480. In other embodiments, the perimeter flow region 492 is divided into two, four, six, or more subregions by the plurality of fins 480. In the illustrated embodiment, each of the eight subregions has a decreasing cross-sectional flow area. The decrease in the cross-sectional flow area of the eight subregions is shown most clearly in FIG. 38 as reflected by angle 486. The angle 486 is defined by the wall 484. In some embodiments, the angle 486 of the wall 484 relative to the central axis 481 of the stream conditioner 440 is greater than 2°, greater than 4°, greater than 8°, greater than 13°, greater than 20°, and/or greater than 30°. In some cases, the angle 486 is approximately 5°. Many variations are possible.

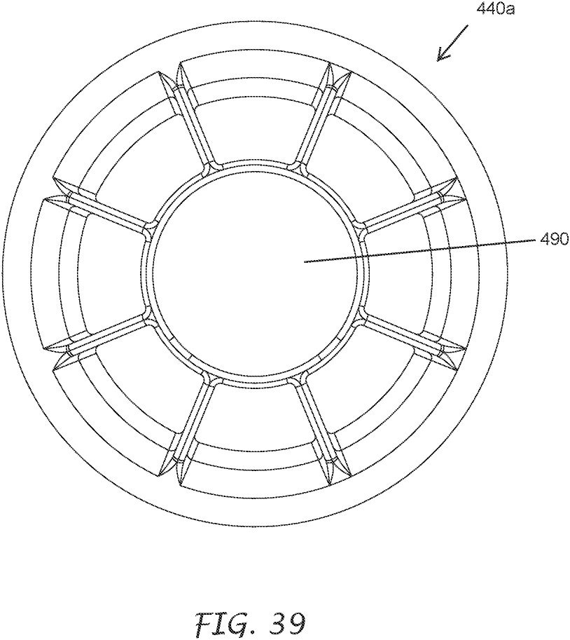

FIG. 39 illustrates an embodiment of a stream conditioner 440a that is similar to the stream condition 440 illustrated in FIG. 37 except the central flow region 490 does not include any fins. In contrast to the central flow region 490 of the stream conditioner 440 (FIG. 37), the central flow region 490 of the stream conditioner 440a is not divided into subregions.

Although certain embodiments and examples are disclosed herein, inventive subject matter extends beyond the examples in the specifically disclosed embodiments to other alternative embodiments and/or uses, and to modifications and equivalents thereof. While we have described and illustrated in detail embodiments of a sprinkler with a high-torque, low-bypass turbine and stator arrangement, it should be understood that our inventions can be modified in both arrangement and detail. Thus, the scope of the claims appended hereto is not limited by any of the particular embodiments described above. For example, the sprinkler 100 could be modified to a simplified shrub configuration without the retraction spring 112 and utilizing a shorter outer body 102. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

For expository purposes, the term “horizontal” as used herein is defined as a plane parallel to the plane or surface of the floor or ground of the area in which the device being described is used or the method being described is performed, regardless of its orientation. The term “floor” floor can be interchanged with the term “ground.” The term “vertical” refers to a direction perpendicular to the horizontal as just defined. Terms such as "above," "below," "bottom," "top," "side," "higher," "lower," "upper," "over," and "under," are defined with respect to the horizontal plane.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

Although the sprinkler has been disclosed in the context of certain embodiments and examples, it will be understood by those skilled in the art that the sprinkler and subassemblies extend beyond the specifically disclosed embodiments to other alternative embodiments and/or uses of the embodiments and certain modifications and equivalents thereof. Accordingly, it is intended that the scope of the sprinkler herein-disclosed should not be limited by the particular disclosed embodiments described above but should be determined only by a fair reading of the claims that follow.

What is claimed is:

1. A rotating sprinkler for irrigation, the sprinkler comprising:
a turret configured to rotate with the sprinkler and comprising:
a chamber;
an inlet in flow communication with the chamber, the inlet being configured to receive pressurized water;
a primary port in flow communication with the chamber, the primary port being configured to receive a primary nozzle; and
a stream conditioner comprising a plurality of fins forming a plurality of flow regions, one or more of the plurality of flow regions having a cross-sectional flow area that decreases in a downstream direction towards the primary port so as to accelerate the pressurized water through the stream conditioner.

2. The rotating sprinkler of claim 1, wherein at least a portion of the stream conditioner is disposed in the primary port.

3. The rotating sprinkler of claim 2, wherein the portion of the stream conditioner forms a press fit in the primary port.

4. The rotating sprinkler of claim 1, wherein the stream conditioner comprises an engagement structure configured to align the stream conditioner with the primary port.

5. The rotating sprinkler of claim 4, wherein the stream conditioner can rotate for less than 360 degrees about its axis relative to the primary port when installed in the turret.

6. The rotating sprinkler of claim 4, wherein the stream conditioner can rotate for less than 5 degrees about its axis relative to the primary port when installed in the turret.

7. The rotating sprinkler of claim 4, wherein the engagement structure of the stream conditioner is one or more notches.

8. The rotating sprinkler of claim 1, wherein the turret comprises an engagement structure configured to engage with the stream conditioner.

9. The rotating sprinkler of claim 8, wherein the engagement structure of the turret is one or more bosses.

10. The rotating sprinkler of claim 1, wherein the plurality of flow regions have a cross-sectional flow area that decreases in a downstream direction towards the primary port.

11. The rotating sprinkler of claim 1, further comprising a nozzle assembly having at least the primary nozzle, wherein the turret comprises a nozzle recess, the primary port being disposed in the nozzle recess, and wherein at least a portion of the nozzle assembly and at least a portion of the stream conditioner are sized and shaped to fit within the nozzle recess.

12. A rotating sprinkler for irrigation, the sprinkler comprising:
an outer body and a tubular structure disposed at least partially in the outer body, the tubular structure being in flow communication with an inlet of the sprinkler;
a turret supported by the tubular structure and comprising:
a chamber;
an inlet in flow communication with the tubular structure and the chamber; and
a nozzle recess in flow communication with the chamber, the nozzle recess being configured to receive a nozzle assembly; and
a stream conditioner positioned in the nozzle recess, the stream conditioner having a central axis and comprising a plurality of fins with one or more flow areas disposed between the plurality of fins, the one or more flow areas having a cross-sectional flow area that decreases in a downstream direction so as to accelerate the water through the stream conditioner.

13. The rotating sprinkler of claim 12, wherein the one or more flow areas are arranged to form a central flow region and a perimeter flow region for water to flow through the stream conditioner.

14. The rotating sprinkler of claim 12, wherein the stream conditioner forms a press fit in the nozzle recess.

15. The rotating sprinkler of claim 12, wherein the stream conditioner comprises an engagement structure configured to engage with the turret.

16. The rotating sprinkler of claim 15, wherein the engagement structure of the stream conditioner is one or more notches.

17. The rotating sprinkler of claim 13, wherein the turret comprises an engagement structure configured to engage with the stream conditioner.

18. The rotating sprinkler of claim 17, wherein the engagement structure of the turret is one or more bosses.

19. A rotating sprinkler for irrigation, the sprinkler comprising:
a housing configured to rotate with the sprinkler and comprising:
an internal chamber;
an inlet disposed in a lower surface of the housing, the inlet being in flow communication with the internal chamber and configured to receive pressurized water;
an outlet in a sidewall of the housing, the outlet being in flow communication with the chamber and sized and shaped to receive a primary nozzle; and
a stream conditioner positioned upstream from the outlet and comprising a plurality of fins sized and shaped to straighten and accelerate a turbulent flow of water from the internal chamber as the water passes between the plurality of fins, the plurality of fins having one or more flow areas disposed between the plurality of fins, the one or more flow areas having a cross-sectional flow area that decreases in a downstream direction towards the outlet so as to accelerate the water through the stream conditioner.

20. The rotating sprinkler of claim 19, wherein the outlet comprises a primary port, the primary port being configured to receive at least a portion of the stream conditioner.
